(19) United States
(12) Patent Application Publication
(10) Pub. No.: US 2021/0273858 A1
(43) Pub. Date: Sep. 2, 2021

(54) Machine-Learned Prediction of Network Resources and Margins

(71) Applicant: Google LLC, Mountain View, CA (US)

(72) Inventors: Ana Radovanovic, Palo Alto, CA (US); Bokan Chen, Sunnyvale, CA (US); Tommaso Nesti, Amsterdam (NL); William D. Heavlin, Half Moon Bay, CA (US)

(21) Appl. No.: 16/972,516

(22) PCT Filed: Jan. 7, 2019
(86) PCT No.: PCT/US19/12517

§ 371 Date: Dec. 4, 2020

Related U.S. Application Data
(60) Provisional application No. 62/697,966, filed on Jul. 13, 2018.

(51) Int. Cl. H04L 12/24; G06N 20/00; G06N 5/04

(52) U.S. Cl. CPC H04L 41/147; H04L 41/12; G06N 5/04; G06N 20/00

(57) ABSTRACT

Provided are methods, systems, devices, apparatuses, and tangible non-transitory computer readable media for network topology analysis and prediction. The disclosed technology can perform operations including receiving network data including information associated with a network including a plurality of nodes respectively associated with resource availability and resource usage. Resource availability can be associated with an amount of a resource available for distribution from a portion of the plurality of nodes at an initial time interval. Further, resource usage can be associated with usage of the resource from the portion of the plurality of nodes at the initial time interval. The network topology, resource availability, and resource usage for a portion of the plurality of nodes at a time interval subsequent to the initial time interval can be determined. Furthermore, one or more predictions for the portion of the plurality of nodes can be generated based on the network data.

### RELATED APPLICATION

The present application is based on and claims benefit of U.S. Provisional Patent Application No. 62/697,966 filed Jul. 13, 2018, which is incorporated by reference herein.

### FIELD

The present disclosure relates generally to the state of networks. More particularly, the present disclosure relates to determining the state of a network using a machine-learned model.

### BACKGROUND

Operations associated with the state of a geographic area can be implemented on a variety of computing devices. These operations can include processing data associated with the geographic area for later access and use by a user or computing system. Further, the operations can include sending and receiving data to remote computing systems. However, the types of operations and the way in which the operations are performed can change over time, as can the underlying hardware that implements the operations. Accordingly, there are different ways to leverage computing resources associated with the state of a geographic area.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method of network topology prediction. The method can include receiving, by one or more computing devices, network data including information associated with a network including a plurality of nodes associated with a resource availability and a resource usage. The resource availability can be associated with an amount of a resource dispatched in association with at least a portion of the plurality of nodes at an initial time interval. The resource usage can be associated with usage of the resource in association with at least a portion of the plurality of nodes at the initial time interval. Further, the method can include determining, by the one or more computing devices, based at least in part on the network data and a machine-learned model, the resource availability and the resource usage for at least the portion of the plurality of nodes at a time interval subsequent to the initial time interval. The method can also include generating, by the one or more computing devices, based at least in part on the network data, one or more predictions for the portion of the plurality of nodes of the plurality of nodes.

Another example aspect of the present disclosure is directed to a computing system including: one or more processors; a machine-learned model trained to receive input data including information associated with a plurality of nodes associated with a resource availability and a resource usage, and based at least in part on the input data, generate output data including one or more predictions associated with at least a portion of the plurality of nodes; and a memory including one or more computer-readable media, the memory storing computer-readable instructions that when executed by the one or more processors cause the one or more processors to perform operations. The operations can include receiving the input data including information associated with a plurality of nodes respectively associated with a resource availability and a resource usage. The resource availability can be associated with an amount of a resource dispatched in association with at least a portion of the plurality of nodes at an initial time interval. The resource usage can be associated with usage of the resource in association with at least the portion of the plurality of nodes at the initial time interval. The operations can include sending the input data to the machine-learned model. The machine-learned model can be configured to determine, based at least in part on the input data, output data that can include the resource availability and the resource usage for at least the portion of the plurality of nodes at a time interval subsequent to the initial time interval. Furthermore, the operations can include, responsive to receiving output data from the machine-learned model, generating, based at least in part on the output data from the machine-learned model, one or more predictions for at least the portion of the plurality of nodes. The one or more predictions can include a resource cost for the resource available for distribution from each of the plurality of nodes at the time interval subsequent to the initial time interval.

Another example aspect of the present disclosure is directed to one or more tangible non-transitory computer-readable media storing computer-readable instructions that when executed by one or more processors cause the one or more processors to perform operations. The operations can include receiving network data including information associated with a network including a plurality of nodes associated with a resource availability and a resource usage. The resource availability can be associated with an amount of a resource available for distribution from a portion of the plurality of nodes at an initial time interval. The resource usage can be associated with usage of the resource from the portion of the plurality of nodes at the initial time interval. The operations can include determining, based at least in part on the network data and a machine-learned model, the resource availability and the resource usage for the portion of the plurality of nodes at a time interval subsequent to the initial time interval. Furthermore, the operations can include generating, based at least in part on the network data, one or more predictions for the plurality of nodes. The one or more predictions can include a resource cost for the resource available for distribution from each of the plurality of nodes at the time interval subsequent to the initial time interval.

Another example aspect of the present disclosure is directed to a computer-implemented method of network topology prediction. The method can include receiving, by one or more computing devices, network data including information associated with a network including a plurality of nodes associated with a plurality of resources. The resource availability can be associated with an amount of a resource dispatched in association with at least a portion of the plurality of nodes at an initial time interval. The resource usage can be associated with usage of the resource in association with at least the portion of the plurality of nodes at the initial time interval. Furthermore, the method can include determining, by the one or more computing devices, based at least in part on the network data and a machine-learned model, data indicative of a topology of the network.

Another example aspect of the present disclosure is directed to one or more non-transitory computer-readable media that store a machine-learned model configured to receive historical data associated with resources at each of a plurality of nodes of a network. The machine-learned model can also be configured to receive second data including a demand associated with a plurality of regions of the network, each region comprising a subset of the nodes of the network. Further, the machine-learned model can be configured to receive third data including a total supply of resources of the network. The machine-learned model can also be configured to generate data indicative of a topology of the network based at least in part on the first data, the second data, and the third data.

Another example aspect of the present disclosure is directed to a computer-implemented method of training a machine-learned model to perform network topology prediction. The method can include receiving, by one or more computing devices, historical training data including historical resource availability, historical resource usage, and a ground-truth resource cost for a resource provided in association with at least a portion of a plurality of nodes over a plurality of time intervals. The method can include sending, by the one or more computing devices, over a plurality of iterations, input data including a portion of the historical training data to a machine-learned model. The portion of the historical training data includes the historical resource availability and the historical resource usage of at least the portion of the plurality of nodes. The machine-learned model can be trained to receive the input data and, based at least in part on the input data, generate output data including a predicted resource cost of a resource provided at each of the plurality of nodes. Further, the method can include obtaining, by the one or more computing devices, at each of the plurality of iterations, the output data from the machine-learned model including the predicted resource cost of the resource provided at each of the plurality of nodes. The method can include determining, by the one or more computing devices, at each of the plurality of iterations, one or more differences between the predicted resource cost and the ground-truth resource cost at each of the plurality of nodes. Furthermore, the method can include adjusting, by the one or more computing devices, at each of the plurality of iterations, one or more parameters of the machine-learned model to minimize the one or more differences between the predicted resource cost and the ground-truth resource cost at each of the plurality of nodes.

Another example aspect of the present disclosure is directed to a computer-implemented method of network topology prediction. The method can include receiving, by one or more computing devices, network data comprising information associated with a network comprising a plurality of nodes. The network data can include resource availability data and resource usage data. The resource availability data can include a total resource availability for the plurality of nodes. The resource usage data can include data indicative of total regional nodal usage. The method can include determining, by the one or more computing devices, based at least in part on the network data and a machine-learned model, data indicative of a topology of the network. Furthermore, the method can include generating, by the one or more computing devices, based at least in part on the network data and the data indicative of the topology of the network, a prediction for at least one of the plurality of nodes.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example computing system that performs network topology determination and prediction according to example embodiments of the present disclosure;

FIG. 2 depicts a block diagram of an example machine-learned model trained to perform network topology determination and prediction according to example embodiments of the present disclosure;

FIG. 3 depicts a diagram of resource costs in a network at different time intervals according to example embodiments of the present disclosure;

FIG. 4 depicts a block diagram of resource generation and usage in a network according to example embodiments of the present disclosure;

FIG. 5 depicts a block diagram of a resource price prediction pipeline according to example embodiments of the present disclosure;

FIG. 6 depicts a diagram of resource generation mix determination according to example embodiments of the present disclosure;

FIG. 7 depicts a flow chart diagram of diagram of transmission line identification according to example embodiments of the present disclosure;

FIG. 8 depicts a heat-map of a segment of a congestion matrix according to example embodiments of the present disclosure;

FIG. 9 depicts a flow chart diagram of an example method to perform network topology determination and prediction according to example embodiments of the present disclosure;

FIG. 10 depicts a flow chart diagram of an example method to perform network topology determination and prediction according to example embodiments of the present disclosure;

FIG. 11 depicts a flow chart diagram of an example method to perform network topology determination and prediction according to example embodiments of the present disclosure;

FIG. 12 depicts a flow chart diagram of an example method to perform network topology determination and prediction according to example embodiments of the present disclosure; and

FIG. 13 depicts a flow chart diagram of an example method to perform network topology determination and prediction according to example embodiments of the present disclosure.

### Reference numerals that are repeated across plural figures are intended to identify the same features in various implementations.

### DETAILED DESCRIPTION

Generally, the present disclosure is directed to the determination of network information and optimization of networks using machine-learned models. For example, a machine-learned model may be used to generate data indicative of a network state based on limited historical operational data associated with the network. The disclosed technology can include the use of a machine-learned model that is trained to determine the state of a network (e.g., an energy network, a communications network, a road network, and/or a water supply network) based on inputs that can include network data (e.g., resource usage data, resource availability data, etc.) associated with at least a portion of the nodes in the network (e.g., total resource usage or demand of nodes in the network). The determined state of a network as described herein may include the topology of a network, including the physical location and/or physical connections between nodes of the network, as well as information relating to operation of the network. In accordance with example embodiments, a machine-learned model may be used to predict state information associated with a network, including topology information, based on limited historical data and/or current resource usage or resource availability data.

In some examples, the network data includes data indicative of a resource availability or supply associated with the network and data indicative of a resource usage or demand associated with the network. More particularly, the resource availability data (e.g., resource supply data) may indicate an amount of resource dispatched (e.g., used or provided) in association with at least a portion of the plurality of nodes of the network. The resource availability data (e.g., resource supply data) may indicate the total amount of resource supply dispatched for the network. The resource availability data (e.g., resource supply data) may indicate supply over a plurality of different resource types. Such data may be referred to as grid-level data as it references a total supply associated with the network or grid. The resource usage or demand data may indicate total regional nodal usage. For example, the resource usage data may indicate a plurality of resource usages associated with a plurality of regions. Each region may include a subset of the plurality of nodes of the network.

For example, the disclosed technology can include a computing system that receives network data that includes information associated with a network that includes a plurality of nodes respectively associated with a plurality of resources. The resource availability can be associated with the amount of a resource available for distribution from at least a portion of nodes at an initial time interval, and the resource usage can be associated with usage of the resource from at least the portion of nodes at the initial time interval. In some examples, the resource availability is total grid-level resource availability and resource usage is total regional nodal usage. Furthermore, the system can, through use of the network data and a machine-learned model, determine network topology information and/or predict various aspects of the network including the state of the network at a future time interval including resource costs, resource usage, and/or resource costs of a portion of the nodes of the network.

As such, the disclosed technology can more effectively determine the state (e.g., the topology and/or distribution of resource production types) of a network through use of a machine-learned model that has been trained using historical data associated with various states and/or aspects of the network in the past. Further, the disclosed technology provides a way to more accurately predict various aspects of a network including resource costs, resource availability, resource usage, whether a node in a network is active, and/or the state of connections between nodes in the network.

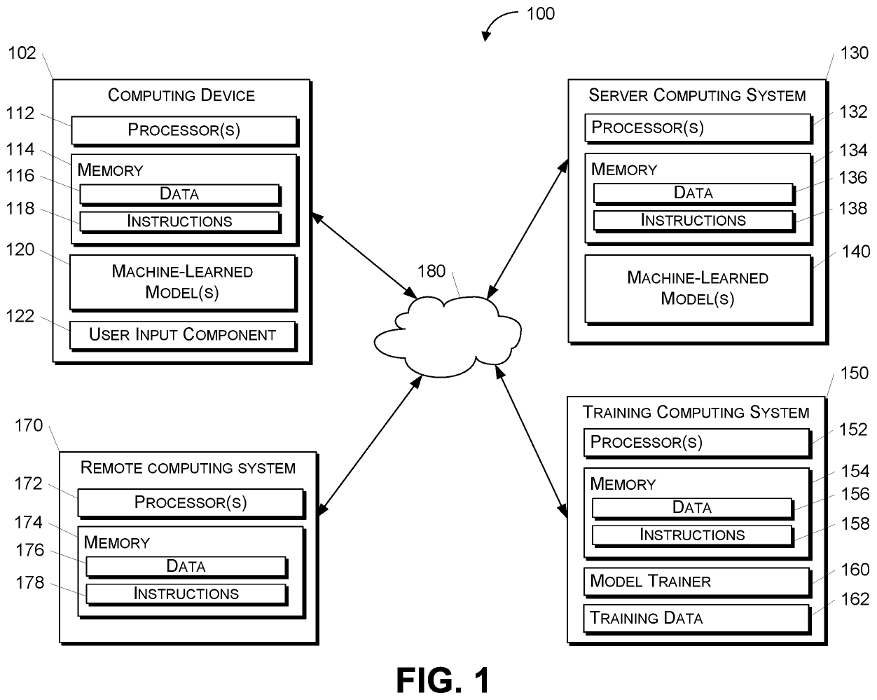

In some embodiments, the disclosed technology can include a computing system (e.g., a network computing system) that can include one or more computing devices (e.g., devices with one or more computer processors and a memory that can store one or more instructions) that can send, receive, process, generate, and/or modify data (e.g., network data associated with the state of a network) including one or more information patterns or structures that can be stored on one or more memory devices (e.g., one or more random access memory devices) and/or one or more storage devices (e.g., one or more hard disk drives and/or one or more solid state memory drives); and/or one or more signals (e.g., electronic signals). The data and/or one or more signals can be exchanged by the computing system with various other systems and/or devices including a plurality of service systems (e.g., one or more remote computing systems, one or more remote computing devices, and/or one or more software applications operating on one or more computing devices) that can send and/or receive data including network data associated with the state of one or more networks (e.g., a power grid network, a communications network, a road traffic network, and/or a water supply network) including the number of nodes in a network, the types of nodes in a network, the location of nodes in a network (e.g., a geographic location and/or a location relative to other nodes), a resource availability of a resource provided by nodes of the network, a resource usage of a resource provided by nodes of a network, a resource cost or price of a resource provided by nodes of a network, and/or the state of connections between nodes of a network (e.g., the state of transmission lines between power stations of an energy grid and/or the state of network connections between networked computers in a communications network). Furthermore, in some embodiments, the network computing system can include one or more features of the computing system 102 that is depicted in FIG. 1. Further, the network computing system can be associated with one or more machine-learned models that include one or more features of the one or more machine-learned models 120 that are depicted in FIG. 1

The network computing system can receive network data. The network data can include information associated with a network including a plurality of nodes (e.g., points in the network that are connected to one or more other points by one or more connections) associated with resource availability and/or resource usage. The resource availability can be associated with an amount of a resource available for distribution from at least a portion of the plurality of nodes at an initial time interval. In some examples, the resource availability is total network resource availability. The resource usage can be associated with usage of the resource from at least the portion of the plurality of nodes at the initial time interval. In some examples, the resource usage is total regional nodal usage. Further, the plurality of nodes can be associated with various other aspects and/or features of the network including resource demand (e.g., a demand for electrical power), resource supply (e.g., a supply of electrical power), the location of the nodes (e.g., a location with respect to other nodes in the network), the node status (e.g., the extent to which a node is operational). Additionally, the network data can include information associated with the state of connections between the plurality of nodes, including a level of congestion between nodes (e.g., congestion associated with links and/or connections between nodes including transmission line congestion in an electrical power grid and/or network congestion of lines in a computer network).

In some embodiments, the network data can include a model for a network including a plurality of nodes (e.g., an electrical power grid in which each of the plurality of nodes corresponds to an electrical power station) that is modelled as a connected graph expressed as:

[symbol] = [symbol] ( [symbol] [symbol] ), in which the set of nodes [symbol] frepresents abuses (e.g., connection points between nodes in the power grid) in the electrical power grid, and the set of edges [symbol] model m transmission lines. Further, the optimal power flow for the plurality of nodes associated with the network can be formulated as:

$${min}_{g} {\sum }_{i = 1}^{n} {C}_{i} ( {g}_{i} ) ,$$

in which Ci can denote the cost function of generating resources at a node i of the network that can be modelled as a quadratic equation. Further, g can be used to denote a generation (e.g., generation of a resource) vector for each node i.

In some embodiments, the resource availability can include available power associated with at least the portion of the plurality of nodes. For example, the resource availability can be associated with the total amount of power that is dispatched (e.g., used or provided) for a grid. Further, the resource usage can be associated with a power demand associated with at least the portion of the plurality of nodes. For example, the resource usage can be the demand for electrical power at a region including a subset of nodes.

In some embodiments, the resource availability can include total regional bandwidth usage associated with at least the portion of the plurality of nodes (e.g., the available network bandwidth from a computing system in a computer network). Further, the resource usage can include bandwidth demand associated with at least the portion of the plurality of nodes (e.g., the amount of network bandwidth that is demanded by a nodal region).

In some embodiments, the network computing system can determine, based at least in part on the network data and a machine-learned model, the resource availability and/or the resource usage for the portion of the plurality of nodes at a time interval subsequent to the initial time interval. For example, the network computing system can determine the amount of available network bandwidth and/or the amount of network bandwidth demand at a time one hour in the future. In some examples, the determined available demand and/or supply using the machine-learned model can be for each node.

In some embodiments, the network computing system can generate, based at least in part on the network data, one or more predictions for at least one of the plurality of nodes. For example, the one or more predictions can include predictions associated with resource costs, resource availability, resource usage, resource capacity, resource demand, resource supply, whether a node in the network is active, the extent to which a node in the network is able to provide a resource, congestion in the network, and/or the state of connections between nodes in the network. Furthermore, the one or more predictions can include one or more predictions associated with one or more margins including marginal costs. For example, the marginal cost can include the additional cost associated with providing an additional unit of energy in a power grid or the additional cost associated with providing additional network bandwidth in a computer network.

In some embodiments, generating one or more predictions for at least one of the plurality of nodes can include generating the one or more predictions based at least in part on the resource availability and the resource usage. For example, the network computing system can generate predictions associated with the cost of energy based on the determined availability and usage of energy.

In some embodiments, the one or more predictions can include a resource cost and/or a resource price for the resource available for distribution from each of the at least one of the plurality of nodes at the time interval subsequent to the initial time interval. The resource cost and/or the resource price can be associated with a value of the resource (e.g., the amount of another commodity or resource that is exchanged to obtain some amount of the resource).

In some embodiments, the network computing system can generate data indicative of at least one network optimization based at least in part on the one or more predictions. In some embodiments, the network computing system may operate at least part of the network according to the at least one network optimization. For example, based on data associated with the one or more predictions (e.g., a predicted future resource availability or demand for a resource at a future time interval) the network computing system can generate one or more control signals that can be used to activate one or more devices and/or systems associated with providing and/or generating the resource. For example, based on one or more predictions that the demand for a resource (e.g., electrical power) will increase in thirty minutes, the network computing system can route more electrical power from one or more electrical power stations and/or increase the amount of electrical power that will be made available by the one or more electrical power stations. In this way, the disclosed technology can more optimally provide a resource in accordance with demand for the resource, which can result in less congestion.

In some embodiments, the network computing system can receive historical training data including (e.g., how much electrical energy was available on certain days or certain hours of the day in the past), historical resource usage (e.g., how much electrical energy was used on certain days or certain hours of the day in the past), and/or a ground-truth resource cost (e.g., the price of energy in the past) for a resource provided at each of a plurality of nodes over a plurality of time intervals. The training data may include historical demand data including total regional nodal usage and historical supply data including total grid dispatched supply.

Further, the network computing system can train the machine-learned model using the historical training data. For example, the historical training data (e.g., electrical energy demand, electrical energy supply, and/or electrical energy price) can be used as an input to train a machine-learned model.

In some embodiments, training the machine-learned model using the historical training data can include sending, over a plurality of iterations (e.g., sending the same set of historical data to the machine-learned model multiple times), a portion of the historical training data to the machine-learned model. The portion of the historical training data can include the historical resource availability and/or the historical resource usage associated with the plurality of nodes and/or the historical resource usage associated with a portion of the plurality of nodes (e.g., all of the plurality of nodes). For example, the portion of the historical training data sent to the machine-learned model can include energy demand and supply, and exclude the price of energy.

In some embodiments, training the machine-learned model using the historical training data can include, responsive to sending the historical training data to the machine-learned model, obtaining, at each of the plurality of iterations, an output of the machine-learned model including a predicted resource cost of the resource provided at each of the plurality of nodes. For example, the network computing system can obtain the output of the machine-learned model after each iteration of the plurality of iterations.

In some embodiments, training the machine-learned model using the historical training data can include determining, at each of the plurality of iterations, one or more differences between the predicted resource cost and the ground-truth resource cost at each of the plurality of nodes or the ground-truth resource cost of the portion of the plurality of nodes. For example, the network computing system can determine the amount and magnitude of differences between actual resource cost and the predicted resource cost provided in the output of the machine-learned model.

In some embodiments, training the machine-learned model using the historical training data can include adjusting, at each of the plurality of iterations, one or more parameters of the machine-learned model to minimize the one or more differences between the predicted resource cost and the ground-truth resource cost at each of the plurality of nodes or at each of the plurality of nodes. For example, based on the accuracy of the machine-learned model's output with respect to ground-truth data, parameters and/or weights of the machine-learned model can be adjusted to improve the accuracy of the machine-learned model.

In some embodiments, the plurality of nodes can be associated with a resource generation type of a plurality of resource generation types. For example, the system may obtain data indicative of a total grid resource supply across different resource types. The data may indicate the total supply for the grid for each resource type. In some examples, the resource generation type can be based at least in part on a generation mechanism associated with one or more of the plurality of nodes (e.g., for an energy resource, the generation type could include a wind type, a coal type, a nuclear type, and/or a solar type corresponding to the way in which the energy is produced).

In some embodiments, the network computing system can generate, for the plurality of nodes at a plurality of time intervals preceding the initial time interval, a plurality of mix vectors including the resource generation type and the resource usage at a portion of the plurality of time intervals preceding the initial time interval. For example, a mix vector for an electrical grid can include a wind power mix vector and a corresponding usage in kilowatts from the wind power mix vector. In some embodiments, the network computing system can determine the resource cost corresponding to each of the plurality of mix vectors at each of the plurality of time intervals preceding the initial time interval.

Further, in some embodiments, the plurality of mix vectors can be scaled (e.g., scaling data in the plurality of mix vectors associated with resource usage and resource availability).

Further, the network computing system can cluster the plurality of mix vectors into a set of mix regimes based at least in part on the resource cost at each of the plurality of time intervals preceding the initial time interval. The plurality of mix regimes can include a distribution of the plurality of mix vectors. For example, the plurality of mix regimes for an energy grid can include the distribution in the amount of energy that is produced by different types of power. By way of further example, the plurality of mix regimes can include a 40% mix of coal power, a 20% mix of nuclear power, a 25% mix of wind power, and a 15% mix of solar power.

In some embodiments, training the machine-learned model using the historical training data can include obtaining, at each of the plurality of iterations, an output of the machine-learned model including determined resource availability and/or determined resource usage at each of the plurality of nodes or at the portion of the plurality of nodes. Further, training the machine-learned model using the historical training data can include determining, based at least in part on the historical training data, a congestion level between each of the plurality of nodes or at the portion of the plurality of nodes (e.g., congestion in links or connections to each of the plurality of nodes). The congestion level can be associated with an amount that the determined resource usage exceeds the determined resource availability at the time interval subsequent to the initial time interval. For example, the congestion level for a computer network can be associated with the amount that demand for bandwidth exceeds available bandwidth and results in slower network traffic.

In some embodiments, the network computing system can determine, based at least in part on the congestion level associated with each of the plurality of nodes at the plurality of time intervals preceding the initial time interval, a congestion regime of a plurality of congestion regimes for the plurality of nodes. The congestion regime can be associated with the plurality of nodes having a congestion level that satisfies one or more predetermined congestion criteria. For example, the congestion regime can include the links and/or connections between nodes in a computer network that exceed threshold levels of packet loss or queuing, or that fall below a threshold throughput level.

In some embodiments, the one or more predetermined congestion criteria can include a predetermined portion of the plurality of nodes (e.g., ten percent of the nodes) being associated with a link having a congestion level that exceeds a predetermined congestion threshold (e.g., a predetermined congestion threshold associated with queue size for a node). Further, the congestion level can be associated with an amount and/or extent of congestion in links and/or connections between a portion of the plurality of nodes in the network.

In some embodiments, training the machine-learned model using the historical training data can include associating each of the plurality of mix regimes with a congestion regime of the plurality of congestion regimes. For example, the machine-learned model can determine associations between a mix regime associated with heavy nuclear power supply and certain congestion regimes associated with a high level of congestion at certain links or connections associated with certain nodes. Further, in some embodiments, associating each of the plurality of mix regimes with a congestion regime of the plurality of congestion regimes can be performed using multinomial logistic regression classification.

In some embodiments, generating, based at least in part on the network data, one or more predictions for the plurality of nodes can include determining the set of resource costs based at least in part on a set of constraints including transmission constraints associated with one or more connections between the plurality of nodes or resource generation constraints associated with an amount of the resource that can be distributed from each of the plurality of nodes. For example, the transmission constraints for a computer network can include constraints associated with the throughput of each computer system in the computer network. By way of further example, the transmission constraints for an energy grid can be associated with the amount of electrical power that can be supplied by an electrical power station.

In some embodiments, the plurality of nodes can be associated with a corresponding plurality of energy distribution locations of an electrical power grid. Further, the resource can include electrical power.

In some embodiments, the network computing system may further control and/or operate at least a part of the network (e.g., the at least one node) based at least in part on the one or more predictions. For example, a rate of resource production, resource consumption, and/or resource cost associated with at least one of the nodes may be controlled in dependence on or based at least in part on the one or more predictions. By way of further example, the network computing system can activate, operate, and/or control one or more systems associated with controlling one or more of the plurality of nodes including controlling one or more network traffic management devices (e.g., routers, network switches, and/or computing devices including one or more processors and a memory storage device) in a computer network and/or controlling one or more devices (e.g., electrical power generators and/or switches) associated with an electrical power generation station in an electrical power grid.

In some embodiments, the network computing system can include one or more processors; a machine-learned model trained to receive input data including information associated with a plurality of nodes associated with a resource availability and a resource usage, and based at least in part on the input data, generate output data including one or more predictions associated with at least portion of the plurality of nodes; and a memory including one or more computer-readable media, the memory storing computer-readable instructions that when executed by the one or more processors cause the one or more processors to perform operations.

In some embodiments, the network computing system can receive input data including information associated with a plurality of nodes associated with resource availability and resource usage. The resource availability (e.g., availability of network bandwidth) can be associated with an amount of a resource dispatched in association with a portion of the plurality of nodes at an initial time interval. Further, the resource usage can be associated with usage (e.g., usage of network bandwidth) of the resource in association with the portion of the plurality of nodes at the initial time interval.

In some embodiments, the network computing system can send the input data to the machine-learned model. The machine-learned model can be configured to determine, based at least in part on the input data, output data including the resource availability and the resource usage for the portion of the plurality of nodes at a time interval subsequent to the initial time interval.

In some embodiments, the network computing system can, responsive to receiving output data from the machine-learned model, generate, based at least in part on the output data from the machine-learned model, one or more predictions for the plurality of nodes. The one or more predictions can include a resource cost for the resource available for distribution from each of the plurality of nodes at the time interval subsequent to the initial time interval.

In some embodiments, the network computing system generating, based at least in part on the network data, one or more predictions for the plurality of nodes can include determining the one or more predictions based at least in part on optimization of a cost function associated with optimal power flow for the plurality of nodes.

In some embodiments, the machine-learned model can include a neural network (e.g., a convolutional neural network) and/or a support vector machine.

In some embodiments, each of the plurality of nodes can be associated with a resource loss value corresponding to an amount of the resource that can be lost in a predetermined time interval before being distributed from a respective node of the plurality of nodes. For example, the resource loss value for an electrical power station in an electrical power grid can include an amount of electrical power that is lost due to heat losses on transmission lines of the electrical grid.

In some embodiments, each of the plurality of nodes or links associated with the nodes can be associated with a congestion value corresponding to a reduction in the rate at which the resource can be distributed from a respective node or link. For example, the congestion value can be associated with the reduction in the speed of transmitting data in a computer network due to congestion in the computer network.

In some embodiments, the network computing system can receive network data including information associated with a network including a plurality of nodes respectively associated with a plurality of resources. The resource availability can be associated with an amount of a resource dispatched in association with at least a portion of the plurality of nodes at an initial time interval. Further, the resource usage can be associated with usage of the resource in association with at least the portion of the plurality of nodes at the initial time interval. Further, the network computing system can determine, based at least in part on the network data and a machine-learned model, a topology of the network. For example, the network computing system can determine the structure of the network including the locations of nodes in the network (e.g., geographical locations of nodes and/or the location of nodes relative to other nodes). Additionally, the network computing system may determine the structure of connections between nodes in the network.

In some embodiments, the network computing system can receive historical data associated with resources at each of a plurality of nodes of a network. The historical data may include historical cost data. Further, the network computing system can receive second data including a demand associated with a plurality of regions of the network. Further, the network computing system can receive third data including a total supply of resources of the network. Furthermore, the network computing system can generate data indicative of a topology of the network based at least in part on the first data, the second data, and/or the third data.

In some embodiments, the machine-learned model can be configured to generate data indicative of a future resource cost associated with one or more of the nodes of the network. For example, the machine-learned mode can generate data indicative of future energy costs and/or prices, based on prior training using historical energy costs and/or prices. Further, the machine-learned mode can generate data indicative of future network bandwidth costs and/or prices, based on prior training using historical network bandwidth costs and/or prices.

In some embodiments, the resource cost can be based at least in part on a cost to service a next increment of resource demand at a given node while satisfying one or more network operating constraints. For example, the cost of providing network bandwidth from a given computing system in a computer network can be based at least in part on network operating constraints including a maximum number of users that can be authorized to use the computing system at one time.

In some embodiments the network computing system can receive historical training data including historical resource availability (e.g., how much network bandwidth was available at certain days or certain hours of the day in the past), historical resource usage (e.g., how much network bandwidth was used at certain days or certain hours of the day in the past), and/or a ground-truth resource cost (e.g., the price of network bandwidth in the past) for a resource provided in association with a plurality of nodes over a plurality of time intervals or a portion of the plurality of nodes over the plurality of time intervals.

The network computing system can send, over a plurality of iterations, input data including a portion of the historical training data to a machine-learned model. The portion of the historical training data can include the historical resource availability and the historical resource usage associated with the plurality of nodes or a portion of the plurality of nodes. Further, the machine-learned model can be trained to receive the input data and, based at least in part on the input data, generate output data including a predicted resource cost of a resource provided at each of the plurality of nodes. For example, the machine-learned model can receive the input data via a computer network connection and provide the output data via the same network connection.

The network computing system can obtain, at each of the plurality of iterations, an output data from the machine-learned model including the predicted resource cost of the resource provided at each of the plurality of nodes. For example, the network computing system can obtain the output from the machine-learned model via a network connection.

The network computing system can determine, at each of the plurality of iterations, one or more differences between the predicted resource cost and the ground-truth resource cost at each of the plurality of nodes. For example, the network computing system can determine differences between the actual price of electrical energy one week ago and the price that was predicted using a machine-learned model provided with input data that did not include the actual price of electrical energy one week ago.

The network computing system can adjust, at each of the plurality of iterations, one or more parameters of the machine-learned model to minimize the one or more differences between the predicted resource cost and the ground-truth resource cost at each of the plurality of nodes. For example, based on the accuracy of the machine-learned model's prediction with respect to the resource cost, parameters and/or weights of the machine-learned model can be adjusted to minimize the differences between the predicted resource cost and the ground-truth resource cost.

In some embodiments, the network computing system can perform one or more operations which can include receiving network data which can include information associated with a network comprising a plurality of nodes respectively associated with a plurality of resources. The resource availability can be associated with an amount of a resource (e.g., water from a network of water reservoirs) dispatched in association with at least a portion of the plurality of nodes at an initial time interval. Further, the resource usage can be associated with usage of the resource in association with at least the portion of the plurality of nodes at the initial time interval.

For example, the network computing system can receive network data via a network (e.g., a wireless or wired network including a LAN, WAN, MAN (Metropolitan Area Network), or the Internet) through which one or more signals (e.g., electronic signals) and/or data can be sent or received from a plurality of nodes, each of which can include one or more computing devices or computing systems (e.g., server computing systems). Further, the plurality of nodes can be remote from the network computing system that receives the network data (e.g., the plurality of nodes can be in different parts of a campus, municipality, county, or other predefined geographic area).

In some embodiments, the network computing system can perform one or more operations which can include determining, based at least in part on the network data and a machine-learned model associated with the network computing system, a topology of the network (e.g., a structure or arrangement of the plurality of nodes in the network). For example, the network computing system can determine the topology of the network based at least in part on receiving data associated with any of the plurality of nodes. The network computing system can for example, determine a topology of the network that includes the currently active set of electrical power generation stations based at least in part on receiving data indicating that certain electrical power stations are on-line and active. Further, the network computing system can determine a topology of the network based on the resource usage (e.g., electrical power usage) of consumers connected to electrical power stations.

In some embodiments, the network computing system can perform one or more operations which can include determining, based at least in part on the network data, one or more predictions for the at least one of the plurality of nodes. For example, the network computing system can generate one or more predictions associated with the amount of electrical power that will be available from a portion of the electrical power stations in an electrical energy grid. Further, the one or more predictions can include a plurality of time intervals with corresponding confidence levels associated with the probability that the value of a parameter associated with the predictions for each of the plurality of time intervals falls within a predetermined range of values.

In some embodiments, the network computing system can perform one or more operations which can include controlling one or more of the plurality of nodes based at least in part on the one or more predictions (e.g., the one or more predictions determined by the network computing system) and/or the determined topology of the network (e.g., the topology determined by the network computing system). For example, the network computing system can perform one or more operations including controlling one or more nodes of the plurality of nodes based on the determined topology (e.g., power generated by one or more electrical power stations associated with the plurality of nodes can be rerouted based on a choke-point in a node). By way of further example, based on one or more predictions that a node will go off-line, the network computing system can generate one or more control signals to control the dispatch of resources (e.g., electrical power from a power station) from another nearby node of the network that can mitigate the loss of electrical power from the node that will go off-line.

In some embodiments, the network computing system can perform one or more operations which can include receiving data including historical data associated with resources at each of a plurality of nodes of a network. For example, the network computing system can receive historical data from one or more remote computing systems associated with the plurality of nodes (e.g., computing systems associated with cellular communications towers that send records of cellular network availability, cellular network usage, and cellular network cost at one or more time intervals in the past).

In some embodiments, the network computing system can perform one or more operations which can include receiving data including second data comprising a demand (e.g., an amount of the resource that is demanded or requested by consumers of the resource) associated with a plurality of regions of the network. Each region can include a subset of the plurality of nodes of the network. For example, the network computing system can receive data including information associated with a demand for cellular network bandwidth in a plurality of regions of the network (e.g., cellular network usage in various geographic regions) in which each region includes a subset of the plurality of nodes.

In some embodiments, the network computing system can perform one or more operations which can include receiving data including third data comprising a supply (e.g., a total supply) of resources of the network. For example, the network computing system can receive data including information associated with a total supply (e.g., an amount of the resource that is available or the total capacity of the network) of cellular network bandwidth the network. By way of further example, the total supply of resources of the network can include a supply of the resources when all nodes of the network maximize their output of the resource.

In some embodiments, the network computing system can perform one or more operations which can include generating data including data indicative of a topology of the network based at least in part on the historical data, the second data, and/or the third data. For example, the network computing system can generate, based on the historical data, the second data, and the third data, data indicating the arrangement and/or relations between the plurality of nodes of the network. By way of further example, the network computing system can generate a topology of an electrical power grid that includes the amount of electrical power that is dispatched by various nodes (e.g., electrical power stations) of the electrical power grid.

Further, in some embodiments, data including data indicative of a topology of the network based at least in part on the historical data, the second data, and/or the third data can be used to control at least part of the network. For example, one or more nodes of an electrical power grid can be activated or deactivated based at least in part on the determined topology of the electrical power grid.

In some embodiments, the network computing system can perform one or more operations which can include generating data indicative of a future resource cost associated with one or more of the nodes of the network. For example, the network computing system can, based at least in part on the input of the historical data, second data, and/or third data to the one or more machine-learned models associated with the network computing system, generate data indicative of the future resource cost of electrical energy at a node (e.g., an electrical power station) of the plurality of nodes in the network.

In some embodiments, the future resource cost can be based at least in part on a cost to service a next increment of resource demand at a given node while satisfying one or more network operating constraints. The one or more network operating constraints can include one or more values (e.g., maximum threshold or minimum threshold values) associated with a resource that constrains operation of the network. For example, the one or more operating constraints for an electrical power grid can include a maximum capacity of an electrical power station. By way of further example, the future resource cost can be based on satisfying an increment of resource demand (e.g., resource demand for cellular network bandwidth) in an upcoming time interval (e.g., the next hour) based on one or more operating constraints including a minimum rate of data transmission through a cellular communication tower of the cellular network.

In some embodiments, the network computing system can perform one or more operations which can include receiving historical training data including historical resource availability, historical resource usage, and/or a ground-truth resource cost for a resource provided in association with at least a portion of a plurality of nodes over a plurality of time intervals. For example, a training computing system associated with the network computing system can receive historical training data (e.g., training data that can include information associated with the past states of the plurality of nodes over a plurality of time intervals) from one or more remote computing systems associated with the plurality of nodes (e.g., computing systems associated with electrical power stations that send records of electrical power availability, electrical power usage, and electrical power cost at one or more time intervals in the past). Further, by way of example, the historical training data can include the amount of resource usage (e.g., electrical energy usage) and ground-truth resource cost (e.g., electrical energy cost) for a portion of the nodes (e.g., half or all of the nodes associated with respective electrical power stations) every week over the period of a year.

In some embodiments, the network computing system can perform one or more operations which can include sending, over a plurality of iterations, input data including a portion of the historical training data to a machine-learned model associated with the network computing system. The portion of the historical training data can include the historical resource availability and/or the historical resource usage associated with the plurality of nodes or a portion of the plurality of nodes. Further, the machine-learned model can be trained to receive the input data and, based at least in part on the input data, generate output data including a predicted resource cost of a resource provided at each of the plurality of nodes.

For example, a training computing system associated with the network computing system can send, via a network, input data (e.g., machine-learned model training data) to the one or more machine-learned models associated with the network computing system. The input data can include historical training data including the amount of the resource (e.g., electrical energy, network bandwidth, and/or water) at each of the plurality of nodes that was available in past time intervals and/or the amount of the resource at each of the plurality of nodes that was used or consumed in past time intervals.

In some embodiments, the network computing system can perform one or more operations which can include obtaining, at each of the plurality of iterations, the output data from the machine-learned model which can include the predicted resource cost of the resource provided at each of the plurality of nodes. For example, responsive to the training computing system associated with the network computing system sending the historical training data to the one or more machine-learned models in the network computing system, the network computing system can obtain, at each of the plurality of iterations, output data from any of the one or more machine-learned models, including information associated with the predicted resource cost of the resource provided at each of the plurality of nodes. Further, the output data can include data associated with the predicted resource cost of the resource provided at each of the plurality of nodes (e.g., the predicted cost of electrical energy).

In some embodiments, the network computing system can perform one or more operations which can include determining, at each of the plurality of iterations, one or more differences between the predicted resource cost and the ground-truth resource cost at each of the plurality of nodes. For example, the training computing system associated with the network computing system can, at each of the plurality of iterations, determine one or more differences between the predicted resource cost and the ground-truth resource cost at each of the plurality of nodes by comparing the predicted resource cost to the ground-truth resource cost. By way of further example, the training computing system associated with the network computing system can determine one or more differences in the predicted cost of electrical energy to the ground-truth electrical energy cost that is included in the historical training data.

In some embodiments, the network computing system can perform one or more operations which can include adjusting, at each of the plurality of iterations, one or more parameters or weights of the machine-learned model to minimize the one or more differences between the predicted resource cost and the ground-truth resource cost at each of the plurality of nodes. For example, the training computing system associated with the network computing system can perform one or more operations including using a loss function to compare the one or more differences between the predicted resource cost of electrical energy and the ground-truth resource cost of electrical energy at each of the plurality of nodes. By way of further example, greater differences between the predicted resource cost and the ground-truth resource cost can result in a greater adjustment of the one or more parameters or weights of the machine-learned model.

In some embodiments, the network computing system can perform one or more operations which can include receiving network data including information associated with a network comprising a plurality of nodes. The network data can include resource availability data and/or resource usage data. Further, the resource availability data can include resource availability data for at least a portion of the plurality of nodes.

The resource availability data can include a total amount of a resource provided (e.g., the total amount or total capacity of wireless network bandwidth available from a network of cellular communications towers) in association with the plurality of nodes. Furthermore, the resource usage data can include data indicative of total regional nodal usage of the resource. For example, the resource usage data can include the total amount of wireless network bandwidth of a portion of the cellular communications towers that is used by consumers of the wireless network's bandwidth (e.g., cellular phone users) in a specified time interval.

By way of further example, the network computing system can receive network data via a network (e.g., a wireless or wired network including a LAN, WAN, MAN (Metropolitan Area Network), or the Internet) through which one or more signals (e.g., electronic signals) and/or data can be sent or received from a plurality of nodes, each of which can include one or more computing devices or computing systems. Further, the plurality of nodes can be remote from the network computing system that receives the network data (e.g., the plurality of nodes can be in different parts of a building, a town, a county, or a region including one or more nations).

In some embodiments, the network computing system can perform one or more operations which can include determining, based at least in part on the network data and a machine-learned model associated with the network computing system, data indicative of a topology of the network. For example, the network computing system can generate, based on the network data and an output from the one or more machine-learned models, data indicating the arrangement and/or relations between the plurality of nodes of the network. By way of further example, the network computing system can generate a topology of communications network that includes the amount of network bandwidth that is directed by various nodes (e.g., computing devices, routers, and switches) of the communications network.

Further, in some embodiments, data including data indicative of a topology of the network based at least in part on the network data and an output from the machine-learned model can be used to control at least part of the network. For example, one or more nodes of the communications network can be adjusted to change the way the respective nodes handle network traffic based at least in part on the determined topology of the communications network.

In some embodiments, the network computing system can perform one or more operations which can include generating, based at least in part on the network data and the data indicative of the topology of the network, a prediction for at least one of the plurality of nodes. For example, the network computing system can generate one or more predictions associated with the total amount of communications network bandwidth that will be available in a communications network at a specified time. Further, the one or more predictions can include a plurality of time intervals with corresponding confidence levels associated with the accuracy of the predictions for each of the plurality of time intervals.

In some embodiments, the price or cost of a resource can be functions of nodal demand and generation. The structure of a network can be represented using pricing regimes, which can be represented via a vector of flags which indicate the marginal status of nodes (e.g., generators in an electrical power grid) and the congestion status of transmission lines (e.g., the transmission lines between nodes) at optimality.

In some embodiments, the Optimal Power Function (OPF) problem, which can be used to optimize nodal generation, can be defined by equations:

$${min}_{g} {J}_{1}^{T} g + \frac{1}{2} {g}^{T} {J}_{2 } g s . t . A g \leq b + E θ ,$$

where g represents the optimization variables denoting the nodal generation, θ=[d \ddot{g}]^{T} is a vector of nodal loads and generation capacities, and J₁∈ [symbol] ⁿ, J₂∈ [symbol] ^{n×n} define the linear and quadratic costs of generation, respectively.

In some embodiments, the matrices A, E, and the vector b can be given as:

$$A = [ \begin{matrix}{1}^{T} \\ - {1}^{T} \\ T \\ - T \\ I \\ - I\end{matrix} ] , b = [ \begin{matrix}0 \\ 0 \\ \overline{f} \\ \underline{f} \\ 0 \\ - \underline{g}\end{matrix} ] , E = [ \begin{matrix}{1}^{T} & {0}^{T} \\ - {1}^{T} & {0}^{T} \\ T & \underline{0} \\ - T & \underline{0} \\ \underline{0} & I \\ \underline{0} & 0\end{matrix} ] θ = [ \begin{matrix}d \\ \overline{g} .\end{matrix} ] .$$

The feasible region of the optimization problem can be convex, compact and polyhedral, thus a polytope. Facets of the feasible region of the optimization problem can correspond to the pricing regimes uniquely defined by the set of marginal generators and congested transmission lines. To that end, if J denotes the index set of constraints of the optimal power function problem, the following sets can be defined:

[symbol]

(θ)={i∈ [symbol] |Aᵢg*=b+Eᵢθ}

[symbol]

^{C}(θ)={i∈ [symbol] |Aᵢg*<b+Eᵢθ}

The set [symbol] can correspond to binding (active) constraints, while [symbol] ^{C} can correspond to non-binding constraints. Accordingly, [symbol] ∩ [symbol] ^{C}=θ and [symbol] ∪ [symbol] ^{C}= [symbol] . The pricing regime can be identified with the corresponding set of binding constraints [symbol] .

In some embodiments, the feasible region can be uniquely partitioned into disjoint open convex polytopes uniquely defined by B. Further, within each pricing regime B, the optimal generation g* and the associated vector of LMPs, can be uniquely defined affine functions of d and g*. Overall, the vector of LMPs over the whole feasible region can be a continuous, piecewise affine function of nodal demand d and optimal generation vectors g*.

The systems, methods, devices, apparatuses, and tangible non-transitory computer-readable media in the disclosed technology can provide a variety of technical effects and benefits to the operation of networks (e.g., energy networks, communications networks, computing networks, road networks, and/or water allocation networks) through use of a computing system that facilitates more effective determination of network states (e.g., network topology) and prediction of future network states (e.g., the availability, usage, and/or cost of resources in nodes of the network).

The disclosed technology can more effectively determine (using a machine-learned model) the topology of a network, thereby providing the benefits of improved resource allocation based on the determined topology. For example, in a network in which nodes of the network produce a resource in different ways (e.g., an energy network in which some energy stations use non-renewable resources and other energy stations use renewable resources), but in which knowledge of the way in which the nodes produce the resource is incomplete, the disclosed technology can be used to determine the way in which each nodes produces the resource.

The disclosed technology can improve the performance of network operation by more effectively determining the state of the network and thereby providing information about the network that can be used to avoid situations in which portions of the network are overtaxed. For example, computing devices in a computing network can be more effectively used by knowing the topology of a network in which the state of all computing devices is not known. More complete knowledge of the network topology can result in better use of bandwidth throughout the computing network. Additionally, improved topology determination can, through identification of bottlenecks and other chokepoints, result in a reduction in congestion throughout the computing network.

The disclosed technology also offers the benefits of more effective prediction of various states of a network including predictions associated with future resource availability, resource usage, and/or resource cost. For example, improved prediction of future resource cost can allow for more efficient use of resources in which high cost resource usage is minimized, thereby allowing, for example, the use of a greater amount of resources at the same resource cost or the use of the same amount of resources at a lower resource cost.

Accordingly, the disclosed technology provides a more effective way to determine the state of a network and/or predict the future state of the network. The disclosed technology may provide a process of controlling at least part of the network based on its determined state and/or predicted future state. For example, where a network node provides or consumes a resource, the rate of production or consumption may be controlled in dependence on the determined state and/or predicted future state. The disclosed technology provides the specific benefits of improved resource allocation, network performance, and future prediction, any of which can be used to improve the effectiveness of a wide variety of networks including electrical power grid networks, communications networks, computing networks, road networks, and/or water allocation networks.

With reference now to FIGS. 1-13, example embodiments of the present disclosure will be discussed in further detail. FIG. 1 depicts a block diagram of an example computing system that performs network topology determination and prediction according to example embodiments of the present disclosure. The system 100 includes a computing device 102, a server computing system 130, a training computing system 150, and a remote computing system 170 that are communicatively connected and/or coupled over a network 180.

The computing device 102 can include any type of computing device, including, for example, a personal computing device (e.g., laptop computing device or desktop computing device), a mobile computing device (e.g., smartphone or tablet), a gaming console, a controller, a wearable computing device, an embedded computing device, and/or any other type of computing device.

The computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, including RAM, ROM, EEPROM, EPROM, flash memory devices, magnetic disks, etc., and combinations thereof. The memory 114 can store data 116 and instructions 118 which are executed by the processor 112 to cause the computing device 102 to perform operations.

In some embodiments, the computing device 102 can perform one or more operations including receiving network data including information associated with a network including a plurality of nodes associated with resource availability (e.g., the amount of the resource that is available or supplied) and/or resource usage (e.g., the amount of the resource that is consumed or demanded). The resource availability can, for example, be associated with an amount of a resource (e.g., electrical power, communications network bandwidth, and/or water) dispatched in association with at least a portion of the plurality of nodes (e.g., nodes associated with distribution or dispatch of the resource) at an initial time interval. Further, the resource usage can be associated with usage of the resource in association with at least a portion of the plurality of nodes at the initial time interval. The one or more operations performed by the computing device 102 can also include determining, based at least in part on the network data and a machine-learned model, the resource availability and the resource usage for at least the portion of the plurality of nodes at a time interval subsequent to the initial time interval. Furthermore, the one or more operations performed by the computing device 102 can include generating, based at least in part on the network data, one or more predictions for the portion of the plurality of nodes of the plurality of nodes.

In some implementations, the computing device 102 can store or include one or more machine-learned models 120. For example, the machine-learned models 120 can include various machine-learned models including neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Example machine-learned models 120 are discussed with reference to FIGS. 1-13.

In some implementations, the one or more machine-learned models 120 can be received from the server computing system 130 over network 180, stored in the memory 114, and then used or otherwise implemented by the one or more processors 112. In some implementations, the computing device 102 can implement multiple parallel instances of a single machine-learned model 120 (e.g., to perform parallel network state determination across multiple instances of the machine-learned model 120). More particularly, the one or more machine-learned models can determine the state of a network (e.g., the topology of the network) and/or predict the state of the network at a future time.

Additionally or alternatively, one or more machine-learned models 140 can be included in or otherwise stored and implemented by the server computing system 130 that communicates with the computing device 102 according to a client-server relationship. For example, the machine-learned models 140 can be implemented by the server computing system 140 as a portion of a web service (e.g., a network state determination and prediction service). Thus, one or more machine-learned models 120 can be stored and implemented at the computing device 102 and/or one or more machine-learned models 140 can be stored and implemented at the server computing system 130.

The computing device 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can include any suitable processing device (e.g., a processor core, a microprocessor, an ASIC, a FPGA, a controller, a microcontroller, etc.) and can include one processor or a plurality of processors that are operatively connected. The memory 134 can include one or more non-transitory computer-readable storage mediums, including RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some embodiments, the server computing system 130 can perform one or more operations including receiving network data including information associated with a network including a plurality of nodes associated with resource availability (e.g., the amount of the resource that is available or supplied) and/or resource usage (e.g., the amount of the resource that is consumed or demanded). The resource availability can, for example, be associated with an amount of a resource (e.g., electrical power, communications network bandwidth, and/or water) dispatched in association with at least a portion of the plurality of nodes (e.g., nodes associated with distribution or dispatch of the resource) at an initial time interval. Further, the resource usage can be associated with usage of the resource in association with at least a portion of the plurality of nodes at the initial time interval. The one or more operations performed by the server computing system 130 can also include determining, based at least in part on the network data and a machine-learned model, the resource availability and the resource usage for at least the portion of the plurality of nodes at a time interval subsequent to the initial time interval. Furthermore, the one or more operations performed by the server computing system 130 can include generating, based at least in part on the network data, one or more predictions for the portion of the plurality of nodes of the plurality of nodes.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the one or more machine-learned models 140 can include various machine-learned models. Example machine-learned models include neural networks or other multi-layer non-linear models. Example neural networks include feed forward neural networks, deep neural networks, recurrent neural networks, and convolutional neural networks. Examples of the one or more machine-learned models 140 are discussed with reference to FIGS. 1-13.

The computing device 102 and/or the server computing system 130 can train the one or more machine-learned models 120 and/or 140 via interaction with the training computing system 150 that is communicatively connected and/or coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, including RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned one or more machine-learned models 120 and/or the one or more machine-learned models 140 respectively stored at the computing device 102 and/or the server computing system 130 using various training or learning techniques, including, for example, backwards propagation of errors. In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the one or more machine-learned models 120 and/or the one or more machine-learned models 140 based on a set of training data 162. The training data 162 can include, for example, historical data describing the state of a network (e.g., a computer network and/or an electrical grid network). For example, the training data can include resource availability, resource usage, resource cost, resource demand, resource supply, the state of connections between nodes in the network, and/or the capacity of nodes in the network.

In some implementations, if the user has provided consent, the training examples can be provided by the computing device 102. Thus, in such implementations, the one or more machine-learned models 120 provided to the computing device 102 can be trained by the training computing system 150 on user-specific data received from the computing device 102. In some instances, this process can be referred to as personalizing the model.

The model trainer 160 can include computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium including RAM hard disk or optical or magnetic media.

In some embodiments, the training computing system 150 can perform one or more operations including receiving network data including information associated with a network including a plurality of nodes associated with resource availability (e.g., the amount of the resource that is available or supplied) and/or resource usage (e.g., the amount of the resource that is consumed or demanded). The resource availability can, for example, be associated with an amount of a resource (e.g., electrical power, communications network bandwidth, and/or water) dispatched in association with at least a portion of the plurality of nodes (e.g., nodes associated with distribution or dispatch of the resource) at an initial time interval. Further, the resource usage can be associated with usage of the resource in association with at least a portion of the plurality of nodes at the initial time interval. The one or more operations performed by the training computing system 150 can also include determining, based at least in part on the network data and a machine-learned model, the resource availability and the resource usage for at least the portion of the plurality of nodes at a time interval subsequent to the initial time interval. Furthermore, the one or more operations performed by the training computing system 150 can include generating, based at least in part on the network data, one or more predictions for the portion of the plurality of nodes of the plurality of nodes.

The remote computing system 170 includes one or more processors 172 and a memory 174. The one or more processors 172 can include any suitable processing device (e.g., a processor core, a microprocessor, an ASIC, a FPGA, a controller, a microcontroller, etc.) and can include one processor or a plurality of processors that are operatively connected. The memory 174 can include one or more non-transitory computer-readable storage mediums, including RAM, ROM, EEPROM, EPROM, flash memory devices, magnetic disks, etc., and combinations thereof. The memory 174 can store data 176 and instructions 178 which are executed by the processor 172 to cause the server computing system 170 to perform operations.

In some implementations, the remote computing system 170 includes or is otherwise implemented by one or more computing devices. In instances in which the remote computing system 170 includes plural computing devices, such computing devices can operate according to sequential computing architectures, parallel computing architectures, and/or some combination thereof. Furthermore, the remote computing system 170 can be associated with one or more of a plurality of nodes in a network which can include electrical power grid networks, communications networks, computing networks, road networks, and/or water allocation networks. Furthermore, the remote computing system 170 can receive one or more signals and/or data from any of the plurality of nodes. The one or more signals or data received from any of the plurality of nodes can indicated one or more states or one or more conditions of any of the plurality of nodes including resource usage, resource availability, and/or resource costs of an associated resource distributed, dispatched, or otherwise provided by any of the plurality of nodes.

The network 180 can be any type of communications network, including a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 1 illustrates one example computing system that can be used to implement the present disclosure. Other computing systems can be used as well. For example, in some implementations, the computing device 102 can include the model trainer 160 and the training dataset 162. In such implementations, the one or more machine-learned models 120 can be both trained and used locally at the computing device 102. In some of such implementations, the computing device 102 can implement the model trainer 160 to personalize the one or more machine-learned models 120 based on user-specific data.

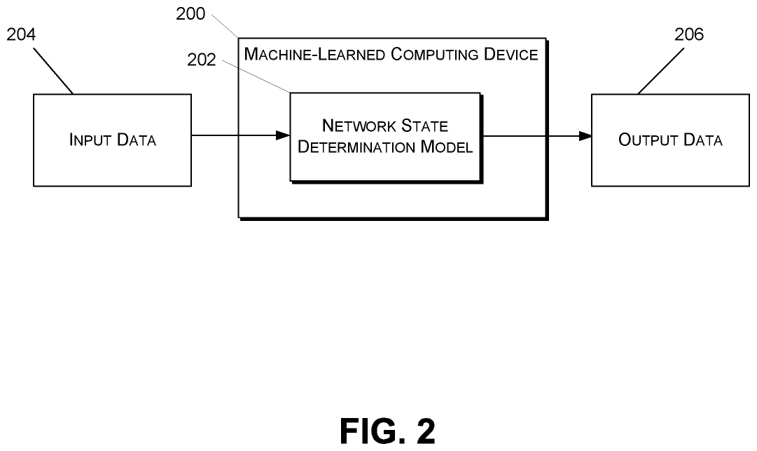

FIG. 2 depicts a block diagram of an example machine-learned model trained to perform network topology determination and prediction according to example embodiments of the present disclosure. A machine-learned computing device 200, which is shown in FIG. 2, can include one or more features of the computing device 102, the server computing system 130, and/or the training computing system 150, which are depicted in FIG. 1.

In some implementations, the machine-learned computing device 200 can be trained to receive a set of input data 204 descriptive of a network (e.g., a network that includes a plurality of nodes) and, as a result of receipt of the input data 204, provide output data 206 that includes a determined state of the network (e.g., the structure of the network including locations of nodes in the network) and/or one or more predictions associated with the network (e.g., predicted resource availability, predicted resource usage, and/or predicted resource cost for each of the plurality of nodes of the network). Thus, in some implementations, the machine-learned model 200 can include a network state determination model 202 that is operable to determine the state of a network associated with the input data 204.

In some implementations, network state determination model 202 can include one or more features of the one or more machine-learned models 120 and/or the one or more machine-learned models 140 which are depicted in FIG. 1. Further, the network state determination model 202 can include one or more machine-learned models including neural networks (e.g., convolutional neural networks and/or deep recurrent neural networks), other multi-layer non-linear models, and/or regression-based models. In some embodiments, the network state determination model 202 can include a recurrent neural network including a multi-layer long short-term memory (LSTM) neural network, and/or a multi-layer gated recurrent unit (GRU) neural network.

The network state determination model 202 can be configured to receive data from various sources. For example, a plurality of remote computing devices (e.g., computing devices associated with one or more nodes of an energy grid, computing devices in a communications network, and/or computing devices associated with a water distribution system) can provide data associated with resource availability and/or resource usage that can be partly or collectively represented as input data 204. Furthermore, the input data 204 can include data associated with the amount of a resource that is available for distribution and/or dispatch; the amount of a resource that is used or consumed; a rate at which a resource can be provided; a maximum or minimum amount of a resource that can be provided in a time interval; and/or historical data including amounts of the resource that were available for distribution or usage in the past.

The network state determination model 202 can be trained to recognize various characteristics and/or patterns of the input data 204 including means, medians, standard deviations, and/or correlations of portions of the input data 204. Further, the network state determination model 202 can output the output data 206 that can include one or more predictions associated with the input data 204.

The network state determination model 202 can be trained using a training dataset (e.g., the training data 162 that is depicted in FIG. 1) including data associated with a plurality of training inputs used to train the machine-learned model to achieve a desired output (e.g., determining future resource costs based on current resource availability and/or current resource usage). The classification dataset can be based in part on inputs to one or more sensors or metering devices associated with a plurality of nodes (e.g., one or more sensors or metering devices that can measure resource capacity, an amount of a resource that is available, an amount of a resource that is used, and/or the rate of providing a resource) that can be provided to the network state determination model 202 as either a raw input or, after being modified by another computing device, as a formatted input (e.g., an input to the network state determination model 202 that is formatted according to a set of predetermined specifications).

The network state determination model 202 can learn and then leverage the historical data associated with a resource to more accurately predict the state of the resource in the future. Further, in some implementations, the network state determination model 202 can include one or more portions associated with a temporal model that allows the input data 204 to be referenced in time. In such implementations, the input data 202 provided as input to the network state determination model 202 can be a sequence of inputs, each input corresponding to the input data 204 obtained at a different time interval. For instance, a time-stepped sequence of input data 204 from multiple nodes associated with a resource can be obtained iteratively.

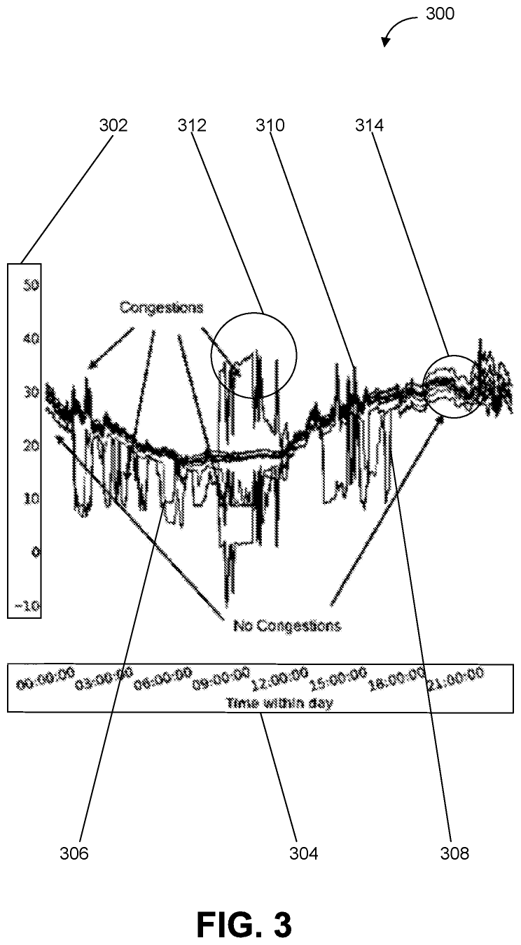

FIG. 3 depicts a diagram of resource costs in a network at different time intervals according to example embodiments of the present disclosure. The outputs illustrated in FIG. 3 can be determined and/or generated by a computing system or computing device that can include one or more features of the computing device 102, the server computing system 130, and/or the training computing system 150, which are depicted in FIG. 1. As shown in FIG. 3, network output data 300 includes a price scale 302, a time scale 304, a node state 306, a node state 308, a node state 310, a congestion region 312, and a congestion region 314.

The network output data 300 can be representative of a network (e.g., an electrical power grid) that can be modeled as a connected graph [symbol] = [symbol] ( [symbol] [symbol] ), where the set of nodes [symbol] represents n buses in the system and the set of edges [symbol] model m transmission lines. The variables g,d∈ [symbol] ⁿ can be used to denote the generation and demand vectors; Cᵢ(⋅) can be used to denote the cost function of generation at node i, which can be modeled as an increasing quadratic function; and g, \ddot{g}∈ [symbol] ⁿ and f, \ddot{f}∈ [symbol] ^{m} can be used to denote the vectors of generation and transmission capacity limits. The Optimal Power Flow (OPF) can then be formulated as the following optimization problem:

$${min}_{g} {\sum }_{i = 1}^{n} {C}_{i} ( {g}_{i} )$$

$$\begin{matrix}s . t . & {1}^{T} ( g - d ) = θ , & : λ \\ & \underline{g} \leq g \leq \overline{g} , & : {τ}^{-} , {τ}^{+} \\ & \underline{f} \leq T ( g - d ) \leq \overline{f} , & : {μ}^{-} , {μ}^{+}\end{matrix} ,$$

where matrix T∈ [symbol] ^{m×n} (e.g., the Power Transfer Distribution Factors matrix (PTDF)), can be used to map nodal generation and demand to active power flows over transmission lines under the assumption of direct current approximation. Further, the operators ≤ and ≥ can be understood entry-wise.

Further, the PTDF matrix can be expressed as T=[0^{DAB-1}]; where the matrices D, A, and B, describe topological and physical properties of the network (e.g., the electrical power grid). In particular, A∈ [symbol] ^{m×(n-1)} can be the sub-matrix of the edge-node incidence matrix Ã of [symbol] obtained by deleting the first column, while B∈ [symbol] ^{(n-1)×(n-1)} can be the sub-matrix of the weighted Laplacian matrix of [symbol] obtained by deleting the first row and the first column. Further, D∈ [symbol] ^{m×m} can be a diagonal matrix with [symbol] = [symbol] , with [symbol] >0 denoting the reactance of line [symbol] ∈ [symbol] . The reduced dimension from n to n−1 can stem from the nullity of the connected grid graph, e.g., Ã1=0.

In order to ensure the uniqueness of the optimal solution without loss of generality, the node corresponding to the first column can be removed from the first column, which is selected as the reference bus. In view of the definitions above, matrix A can be a full-column rank matrix, and B can be strictly positive definite with non-positive off-diagonal entries. The scalar λ and the vectors τ+, τ−, μ+, μ− can be the Lagrange multipliers of the corresponding equations.

In some embodiments, generalizations of the OPF optimization formulation can include additional operational constraints, including ramping up and/or ramping down constraints, power factor constraints, as well as treatments of the reactive power transfer and voltage variation bounds. Furthermore, in some embodiment LMPs (e.g., Locational Marginal Prices) can be the shadow prices of the real power balance constraints of the OPF. Further, the LMPs can be represented as:

$$LMP = \frac{\partial ℒ}{\partial d} = \text{?} + {T}^{T} μ \text{?} where \frac{\partial ℒ}{\partial d}$$

$$\text{?} \text{indicates text missing or illegible when filed}$$

denotes the partial derivative of the Lagrangian function of the OPF evaluated at the optimal solution, and μ=μ⁻−μ⁺. The entries of μ corresponding to uncongested lines ( [symbol] < [symbol] < [symbol] ) can be equal to zero, while the components corresponding to congested lines can be different than zero (in particular, [symbol] >0 iff [symbol] = [symbol] and [symbol] <0 iff [symbol] = [symbol] ). As a consequence, if there are no congested lines, all LMPs are equal, e.g., LMPᵢ=λ, ∀i∈ [symbol] , and the common value λ in the LMP can be called the marginal energy component (MEC),In some embodiments, the energy component reflects the marginal cost of energy at the reference bus. Optionally, if some lines are congested, we can have μ≠0 and, thus, the LMPs are different. The second term \ddot{π}=T^{T}μ can be called the marginal congestion component (MCC); in particular, \ddot{π}ᵢ can reflect the marginal cost of congestion at bus i relative to the reference bus. When LMPs are calculated, the LMPs can also include the loss component, which is related to the heat dissipated on transmission lines, and can be negligible compared to the other price or cost components. In order to obtain the marginal congestion components \ddot{π}, the first entry of LMP can be subtracted from all entries of LMP, to obtain a difference between the nodal marginal congestion prices and the marginal congestion price at the first node. In some embodiments, \tilde{π} can be referred to as the marginal congestion price vector.

In some embodiments, the marginal congestion price vector (excluding the reference bus) can be presented as: π=B⁻¹A^{T}Dμ=B⁻¹s∈ [symbol] ⁿ⁻¹, where s=A^{T}Dμ. Further, s can contain the information on the congested lines since s= [symbol] , where [symbol] ∈ [symbol] ⁿ⁻¹ is the [symbol] -th column of A^{T}. Thus, by stacking historical π, s for T different time intervals as columns of the matrices Π, S∈ [symbol] ^{(n-1)×T-}, which can be rewritten in matrix form as Π=B⁻¹S. The previous relationship and properties of matrices B and S can be used to recover diverse congestion regimes that occur in a network (e.g., an electrical power generation grid) and which are illustrated in FIG. 3.

For example, in FIG. 3, the network output data 300 can represent the output from a computing device (e.g., the computing device 102) that is used to monitor and/or control the state of a network (e.g., a network including a plurality of nodes, each of which is associated with the generation and/or provision of a resource). The network output data 300 can include the node state 306 and the node state 308, each of which correspond to the state of respective nodes of resource providers (e.g., electrical power generation stations in an electrical grid). The price 302 represents a price scale that can be used to determine the price of a resource provided by a node (e.g., a node corresponding to the node state 306 and/or the node state 308) at a particular time based on the node state (e.g., the node state 306 and/or the node state 308) with respect to the time scale 304 which includes times of day over a predetermined time period (e.g., twenty-four hours).

For example, the node state 306 can indicate that the price of a resource (e.g., electrical energy) generated by a node is ten units (e.g., ten units on the price scale 302) at the time interval of 6:00 hours (e.g., four o'clock a.m.). Furthermore, the node state 308, which indicates the state of the same node at a different time interval can indicate that the price of the resource generated by the node is twenty units (e.g., twenty units on the price scale 302) at the time interval of 18:00 hours (e.g., six o'clock p.m.). The different lines illustrated in the network output data 300 can represent different nodes. For example, the line indicated by the node state 310 can indicate the state of a different node from the node associated with the node state 306 and the node state 308. Furthermore, the congestion area 312 and the congestion area 314 can indicate a time interval at which a node is congested (e.g., the demand for an amount of a resource from a node exceeds the amount of the resource that can be provided by the node).

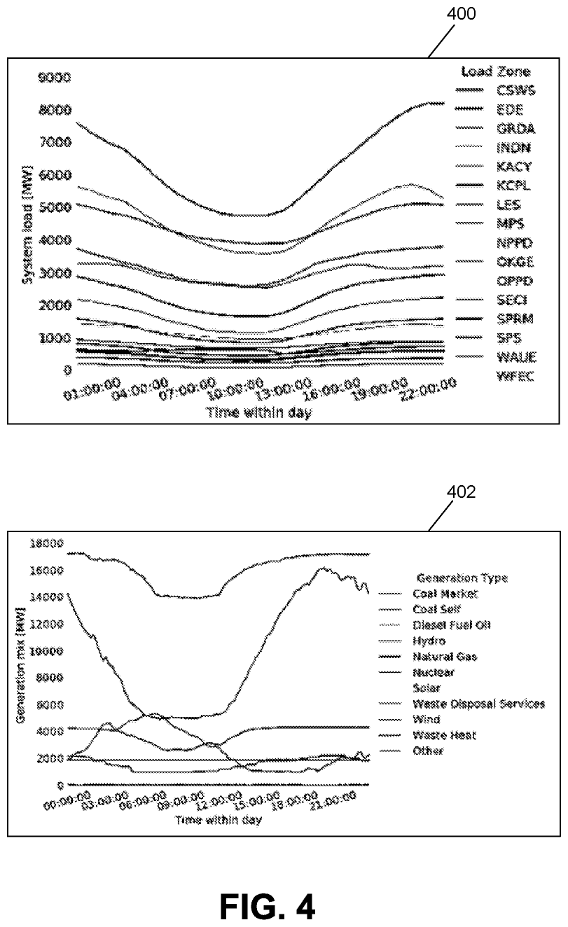

FIG. 4 depicts a block diagram of resource generation and usage in a network according to example embodiments of the present disclosure. Network output data 400 and network output data 402 can be generated by a computing device or computing system that includes one or more features of the computing device 102, the server computing system 130, and/or the training computing system 150, which are depicted in FIG. 1.

The network output data 400 includes a historical generation mix of a network that is recorded with a 5 minute time granularity, and equals the total average power produced across different resource generation types (e.g., coal, natural gas, wind, solar, and/or nuclear). As illustrated in the network output data 402, the system load mix can include regionally aggregated average demand values recorded at hourly time granularity, with 16 different load zones.

In addition to the grid level mix and the regional load data, operators of nodes (e.g., nodes in a resource generation network) can release the corresponding real-time nodal prices at 5 min time granularity.

At any real-time interval t, MIX can refer to the vector of concatenated normalized generation mix, normalized system load, and scaled total demand, e.g., where the normalized generation of type γ can equal Σ_{i∈s}_{_{γ}}gᵢ(t)/Σ_{γ}Σ_{i∈s}_{_{γ}}gᵢ(t) (Sγ being equal to the set of generators of type γ), system load λ's normalized demand equals Σ_{i∈s}_{_{γ}}dᵢ(t)/Σ_{γ}Σ_{i∈s}_{_{γ}}gᵢ(t) x (Sγ being equal to the set of load nodes belonging to the system load λ), and the scaled total load entry of the MIX vector equals Σ_{γ}Σ_{i∈s}_{_{γ}}dᵢ(t)/Averageₜ[Σ_{γ}Σ_{i∈s}_{_{γ}}dᵢ] (where Averageₜ is used to denote the sample average of the total, grid level, demand).

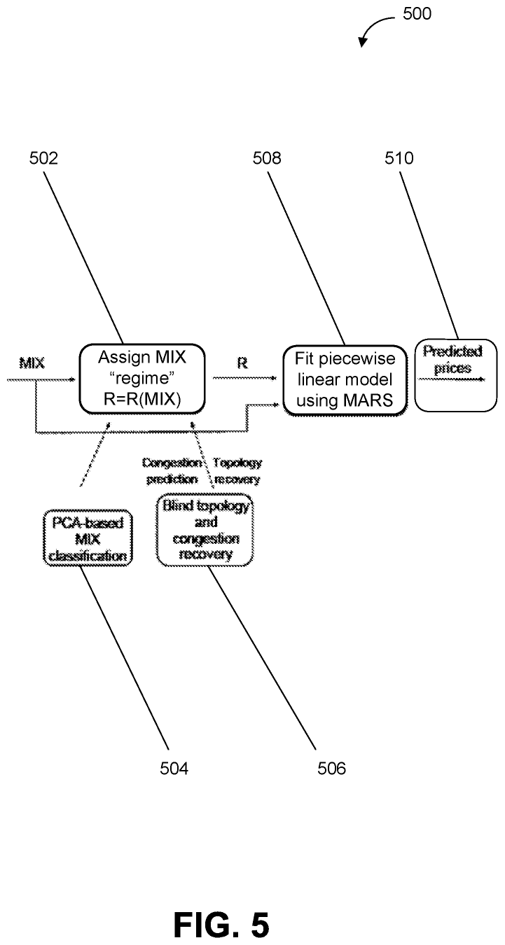

FIG. 5 depicts a block diagram of a resource price prediction pipeline according to example embodiments of the present disclosure. One or more operations performed in resource price production pipeline 500 can be performed by one or more computing devices or computing systems that can include one or more features of the computing device 102, the server computing system 130, and/or the training computing system 150, which are depicted in FIG. 1. The resource price production pipeline 500 can include one or more operations including assigning mix regime 502 which can be based at least in part on PCA based MIX classification 504 and blind topology and congestion recovery 506. Further, the resource price production pipeline 500 can include use of a linear model. The output of the resource price production pipeline 500 can include one or more predicted prices 510.

Within each MIX regime, all generators of the same type (e.g., wind, and/or natural gas) can preserve their production fraction with respect to the total grid level generation of the same type. Further, load within the same geographic region can preserve the same consumption ratio when compared to the total load in the region.

In some embodiments, a grid-level increase in, for example wind supply, can be treated as proportionally equal across all wind plants on the specific grid. Further, the constant ratio, in general, can change from one MIX regime to another within a predetermined time period (e.g., a day). This assumption can enable us to extend the piecewise affinity and parametrize the pricing regimes using MIX vectors, and cannot be validated given that the local, nodal, load and generation data may not be available. However, as a consequence, the piecewise affinity and continuity across disjoint convex polytopes can be utilized to efficiently fit the Multivariate Adaptive Regression Splines (MARS) models and recover nodal LMP vector as a function of MIX vectors.

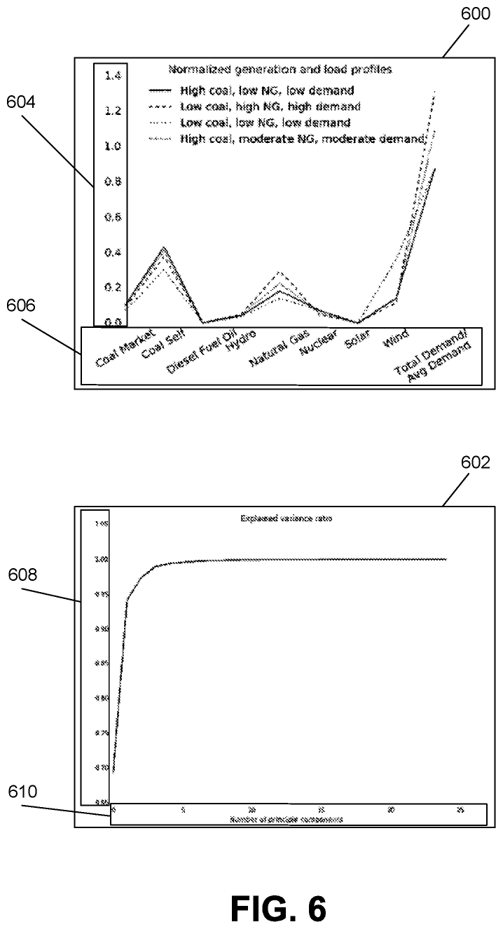

FIG. 6 depicts a diagram of resource generation mix determination according to example embodiments of the present disclosure. The network output data 600 and/or the network output data 602 can be generated by a computing device or computing system that includes one or more features of the computing device 102, the server computing system 130, and/or the training computing system 150, which are depicted in FIG. 1.

MIX vectors can be classified by first applying Principal Component Analysis (PCA) using time indexed MIX vectors. Further, k-means clustering can be performed using the obtained lower dimensional MIX representations, where, by applying the elbow method, 4 MIX clusters can be produced. As shown in network output data 602, the PCA can indicate that four dominant principal components explain 98% of the variance. Further, the same property can be preserved across different time horizons.

Using the structural properties blind matrix factorization can be performed to recover the congestion matrix S. B and S can include the following structural properties: (i) B is a positive definite M-matrix and is sparse, and (ii) S is sparse and low-rank. The sparsity of B follows from the fact that the graph underlying a network (e.g., a power grid) can be weakly connected. The fact that S is sparse and low-rank follows from its definition and the fact that in some scenarios only a very small subset of transmission lines (e.g., transmission lines between nodes of the network) get congested.

Matrices B and S can be obtained by solving the following convex relaxation:

$${min}_{B , S} {‖ S ‖}_{1} + {κ}_{1} tr ( PB ) - {κ}_{2} log \vert B \vert$$

$$s . t . B \prod = S , B ∈ C \text{?} , \\ \text{?} \text{indicates text missing or illegible when filed}$$

with P=I−11^{T}, C:={B:B [symbol] 0, B≤I}, k₁, k₂≥0, and B [symbol] 0 denoting a positive semidefinite matrix.

The ≤ operator can be understood entry-wise. Given that the previous semidefinite program is hard to solve for large grids (e.g., on the order of approximately 1000× nodes), the Alternating Direction Methods of Multipliers (ADMM) can be used to solve the program iteratively. Using a price matrix factorization B can first be replaced with three copies, B⁽¹⁾;B⁽²⁾;B⁽³⁾, which can yield an equivalent formulation, and then define the matrices M₁₂;M₁₃;M₁₄ to be the Lagrange multipliers corresponding to the equality constraints of this new formulation.

Every iteration of the ADMM can consist of three steps, during which the variables and the Lagrange multipliers can be updated by solving appropriate optimization problems, which are expressed in terms of the solutions computed at the previous steps and iterations. Leveraging the existence of closed form solutions for these optimization problems, the ith iteration of the ADMM can read:

$${B}^{( 1 ) , i + 1} = ( {B}^{( 2 ) , i} - {M}_{12}^{i} + {B}^{( 3 ) , i} - {M}_{13}^{i} + ( S - M ) {\prod }^{T} - \frac{\text{?}}{\text{?}} P ) {( 2 I + \prod {\prod }^{T} )}^{- 1} , \\ {B}^{( 2 ) , i + 1} = min ( B \text{?} + {M}_{12}^{i} , I ) , \\ {B}^{( 3 ) , i + 1} = U diag ( \{ \frac{1}{2} ( \text{?} + \sqrt{{s}_{k}^{2} + 4 \frac{{κ}_{2}}{ρ} ) )} \} ) {U}^{T} , \\ {S}^{i + 1} = ( B \text{?} \prod + {M}^{i} ) ⊙ {Y}^{( i + 1 )} , \\ {M}_{12}^{i + 1} = {M}_{12}^{i} + ρ ( {B}^{( 1 ) , i + 1} - B \text{?} ) , \\ {M}_{13}^{i + 1} = {M}_{13}^{i} + ρ ( {B}^{( 1 ) , i + 1} - B \text{?} ) , \\ {M}^{i + 1} = {M}^{i} + ρ ( B \text{?} \prod - {S}^{i + 1} ) ; \\ \text{?} \text{indicates text missing or illegible when filed}$$

where B^{(1),0}=B^{(2),0}=B^{(3),0}=I,S⁰=B^{(1),)}Π, M₁₂⁰=M₁₃⁰=0, M⁰=0, s, U are the eigenvalues and eigenvectors obtained through eigen decomposition of ^{0.5}·(B^{(1),i+1}+M₁₃ⁱ)(B^{(1),i+1}+M₁₃ⁱ)^{T}, and Y⁽ⁱ⁺¹⁾ is defined entry-wise as

$${( {Y}^{( i + 1 )} )}_{kh} = max ( 0 , 1 - \frac{{κ}_{2}}{p \vert {( {B}_{1}^{i + 1} \prod + M \text{?} )}_{kh} \vert} ) . \\ \text{?} \text{indicates text missing or illegible when filed}$$

The minimum operator can be understood entry-wise.

The network output data 600 can represent generation and load profiles for a plurality of resource types (e.g., natural gas, solar power, and/or wind power). Further, the network output data 600 can include a generation output 604 (e.g., an amount of a resource that is generated) and a resource type 606 (e.g., a type of resource that is being generated). Furthermore, the network output data 602 can indicate a variance ratio of the most demanded resource types from the network output data 600 with the portion of the variance ratio indicated by the scale 608 and the number of principal components indicated by the scale 610.

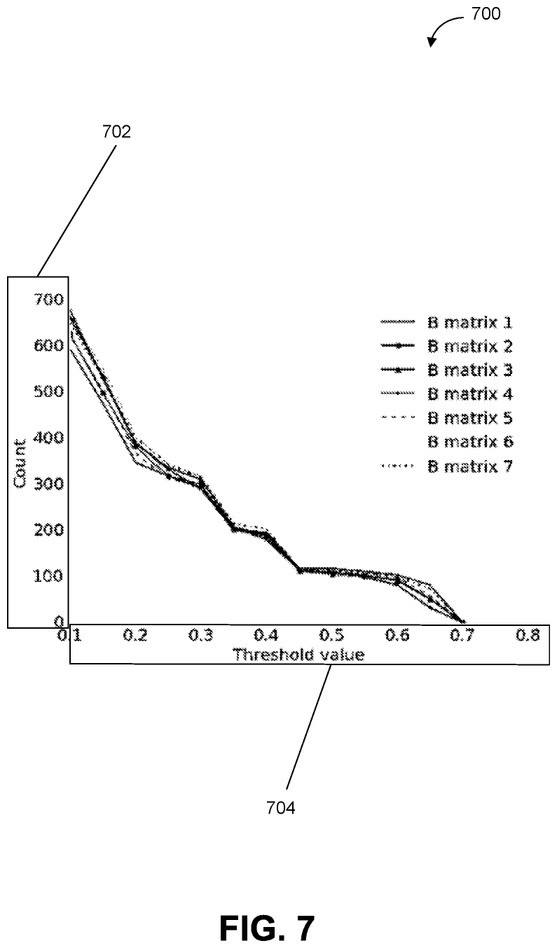

FIG. 7 depicts a diagram of transmission line identification according to example embodiments of the present disclosure. The output 700 can be generated by a computing device or computing system that includes one or more features of the computing device 102, the server computing system 130, and/or the training computing system 150, which are depicted in FIG. 1.

In some embodiments, nodal connections slowly change due to sporadic repairs and new nodes and, in some instances B can be approximately constant. Based at least in part on historical network data which can include real time market prices over a predetermined time period (e.g., seven weeks) the matrix recovery algorithm can be used to infer B_{w,1}, B_{w,2}, B_{w,3}, . . . , B_{w,T}. To evaluate the difference in the recovered links, entry-wise normalization of all the recovered matrices can be performed by dividing each entry with the entry-wise maximum absolute value to obtain scaled matrices \hat{B}_{w,1}, \hat{B}_{w,2}, \hat{B}_{w,3}, . . . , \hat{B}_{w,T}. Then, the identified links (e.g., the identified links associated with the identified links count 702) can be counted by counting off-diagonal entries with absolute values exceeding some given threshold value (e.g., the threshold values associated with the threshold value scale 704).

The result of counting the identified grid links for a given threshold across all recovered matrices can exhibit a surprising proximity, despite the variable impact of the numerical precision criteria of the blind recovery algorithm, as well as changing link reactances due to various factors including weather conditions and/or variations in heating induced by the energy transfer.

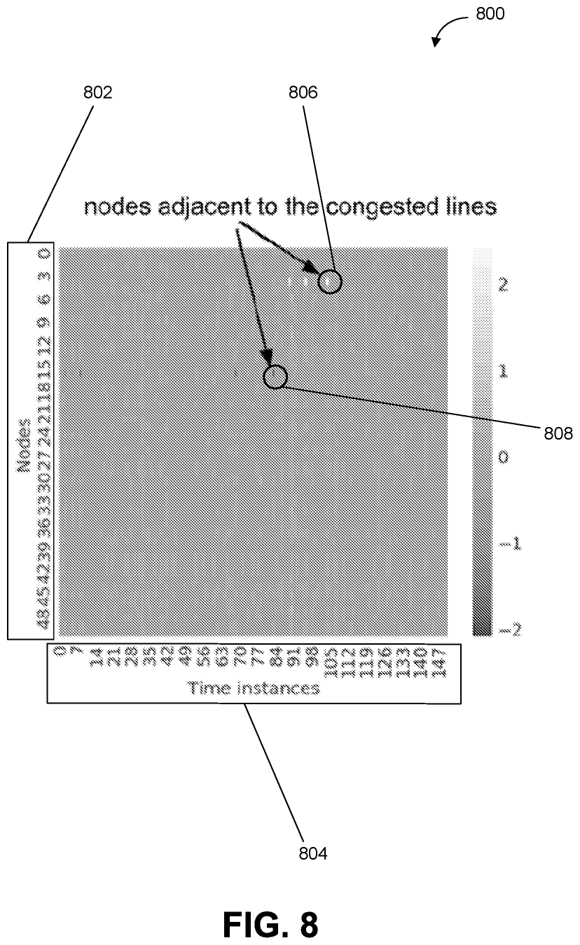

FIG. 8 depicts a heat-map of a segment of a congestion matrix according to example embodiments of the present disclosure. Output 800 (e.g., output that represents a heat-map of a segment of a congestion matrix) can be generated by a computing device or computing system that includes one or more features of the computing device 102, the server computing system 130, and/or the training computing system 150, which are depicted in FIG. 1.

Apart from the topology matrix B, the blind matrix recovery algorithm can recover a congestion matrix S which is represented in the output 800. By clustering columns of the recovered matrices S, each MIX regime can end up having one dominant congestion regime. By using multinomial logistic regression classification, the deviation from a typical MIX vector within each MIX regime to a congestion cluster can be mapped. In some embodiments, misclassification can occur in some instances of the MIX regimes and can correspond to price spikes (bursts) in real time price.

Furthermore, the output 800 illustrates a heat-map of a segment of a congestion matrix in which nodes are represented on the vertical axis 802 and time instances are represented on the horizontal axis 804. As shown in the output 800, nodes adjacent to congested line include the nodes indicated by the region 806 and the region 808.

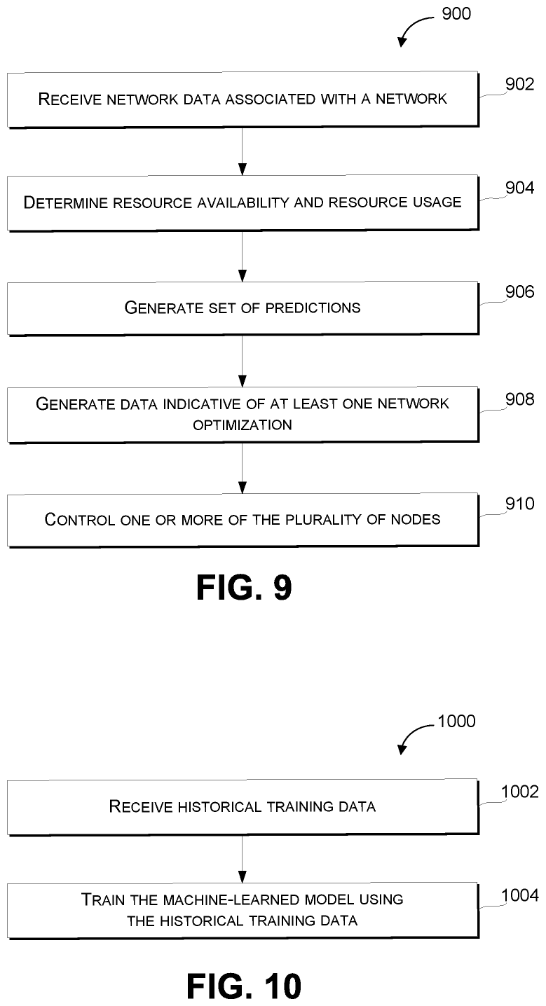

FIG. 9 depicts a flow chart diagram of an example method to perform network topology determination and prediction according to example embodiments of the present disclosure. One or more portions of the method 900 can be executed or implemented on one or more computing devices or computing systems including, for example, the computing device 102, the server computing system 130, and/or the training computing system 150. Further, one or more portions of the method 900 can be executed or implemented as an algorithm on the hardware devices or systems disclosed herein. FIG. 9 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 902, the method 900 can include receiving network data that can include information associated with a network comprising a plurality of nodes respectively associated with resource availability and/or resource usage. The resource availability can be associated with an amount of a resource dispatched (e.g., electrical energy dispatched from electrical power stations) in association with at least a portion of the plurality of nodes at an initial time interval (e.g., a time interval that can have a duration including seconds, minutes, hours, days, weeks, months, years, and/or any other intermediate duration). In some embodiments, the resource availability is associated with an amount of a resource available for distribution (e.g., natural gas in a natural gas storage station that is available for distribution to consumers) from a portion of the plurality of nodes at an initial time interval.

Furthermore, the resource usage can be associated with usage of the resource in association with at least the portion of the plurality of nodes at the initial time interval. For example, the resource usage can be associated with the amount of natural gas of a portion of the natural gas storage stations that is used by consumers of the natural gas distribution system (e.g., residential or commercial natural gas users).

By way of further example, the computing device 102 can receive network data via the network 180 (e.g., a wireless or wired network including a LAN, WAN, MAN (Metropolitan Area Network), or the Internet) through which one or more signals (e.g., electronic signals) and/or data can be sent or received from a plurality of nodes, each of which can include one or more computing devices or computing systems (e.g., the server computing system 130). Further, the plurality of nodes can be remote from the computing device 102 that receives the network data (e.g., the plurality of nodes can be in different parts of a building, city, state or province, or other predefined region).

Furthermore, in some embodiments, the plurality of nodes can include one or more computing devices or computing systems that are associated with information on the state or condition of the one or more resources. For example, the plurality of nodes can include one or more computing devices or computing systems that receive network data from one or more sensors or one or more metering devices that are used to determine the total amount of a resource among a set of the plurality of nodes (e.g., all of the plurality of nodes or the plurality of nodes in a specified region), the availability of a resource (e.g., the amount of a resource that is available from each of the plurality of nodes at a specified time interval which can include current resource availability at a node or set of nodes), or usage of a resource (e.g., the rate of usage of a resource). Further, the resources can include energy resources (e.g., electrical power generated by hydroelectric dams, solar panels, by wind turbines, coal power stations, fossil fuels power stations, geothermal power stations, wave or tide power stations, and/or nuclear power stations), communications network resources (e.g., wireless communications network resources or wired communications network resources), water resources (e.g., water reservoir resources), and/or road traffic system resources (e.g., road, street, and parking availability and usage).

In some embodiments, the resource availability can be associated with an amount of a resource available for distribution or dispatch from a portion of the plurality of nodes at an initial time interval. For example, the computing device 102 can receive network data including data associated with an amount of electrical energy that is available for distribution (e.g., transmitted from one or more nodes associated with one or more respective electrical power stations) at an initial time interval which can be the time interval at which a request for the network data was sent by the computing device 102 to a computing system (e.g., the server computing system 130) associated with a portion of the plurality of nodes (e.g., a group of electrical power stations in an electrical power grid).

In some embodiments, the network data can include resource availability data indicative of a total resource supply dispatched in association with the plurality of nodes during the initial time interval. For example, the network data can include information associated with a total supply of electrical energy (e.g., an amount of electrical energy in kilowatts or megawatts) that is distributed from a plurality of electrical power stations at the initial time interval (e.g., the time at which the network data was sent from a computing system associated with the plurality of nodes to the computing device 102).

Further, the network data can include resource usage data indicative of a plurality of resource usages associated with a plurality of regions during the initial time interval, each region including a subset of the plurality of nodes. For example, the network data can include information associated with usage of electrical energy (e.g., usage of electrical energy measured in kilowatts or megawatts) that is associated with geographic regions (e.g., cities, towns, or counties) during the initial time interval (e.g., the time at which the network data was sent from a computing system associated with the plurality of nodes to the computing device 102).

In some embodiments, the total resource supply is across a plurality of different resource types. For example, the total resource supply in an electrical energy grid can include electrical energy generated from resource types including hydroelectric power, solar power, wind turbine power, coal power, fossil fuel power, geothermal power, wave or tidal power, and/or nuclear power.

In some embodiments, the resource availability can include power supplied, distributed, or dispatched in association with at least the portion of the plurality of nodes (e.g., electrical power dispatched from a plurality of nodes associated with electrical power stations). Further, the resource usage can include power demanded or consumed of at least the portion of the plurality of nodes (e.g., electrical power demanded by consumers of electrical energy provided by electrical power stations associated with the portion of the plurality of nodes).

In some embodiments, the resource availability can include bandwidth availability associated with at least the plurality of nodes (e.g., an amount of communications network bandwidth that is available from the plurality of nodes). Further, the resource usage can include bandwidth demand of at least the portion of the plurality of nodes (e.g., an amount of communications network bandwidth that is demanded by consumers of at least a portion of the plurality of nodes).

In some embodiments, the plurality of nodes can be associated with a corresponding plurality of energy distribution locations of an electrical power grid. For example, the plurality of nodes can be associated with the geographic locations of respective energy distribution locations (e.g., latitude and longitude of electrical power stations). Further, the resource associated with the plurality of nodes can include electrical power, communications network bandwidth, water availability, and/or road traffic resources (e.g., available road space).

In some embodiments, each of the plurality of nodes can be associated with one or more resource generation types of a plurality of resource generation types (e.g., electrical energy generated by electrical power stations). Further, the resource generation type can be based at least in part on a way that each of the plurality of nodes generates the resource (e.g., electrical energy generated by resource generation types including hydroelectric dams, solar panels, by wind turbines, coal power stations, fossil fuels power stations, geothermal power stations, wave or tide power stations, and/or nuclear power stations).

In some embodiments, each of the plurality of nodes can be associated with a resource loss value corresponding to an amount of the resource that is lost in a predetermined time interval before being distributed from a respective node of the plurality of nodes. For example, each of the plurality of nodes in a water distribution system can be associated with a resource loss value (e.g., a leakage value) that represents the amount (e.g., an amount of water per ten meters of water pipe) that leaks from a water pipe in the water distribution system every hour. By way of further example, the resource loss value for an electrical grid can be associated with the amount of electrical energy that is lost during transmission of electricity from a power station to a consumer of the electricity.

In some embodiments, each of the plurality of nodes can be associated with a congestion value corresponding to a reduction in the rate at which the resource can be distributed from a respective node of the plurality of nodes. For example, the congestion value in a communications network can be associated with a reduction in the data transmission rate as a greater portion of the communications network's bandwidth is consumed. By way of further example, the congestion value in an energy grid can be associated with a reduction in the amount of electricity that is transmitted when an electrical power station is at or close to its maximum operational capacity.

Further, the congestion value can be associated with a reduction in the rate at which a resource is distributed, dispatched, or can travel through a system due to blockages and/or choke-points among the plurality of nodes. For example, construction or a traffic accident in a transportation network can reduce the rate at which vehicles in the transportation network are able to travel.

At 904, the method 900 can include determining, based at least in part on the network data and a machine-learned model, the resource availability and the resource usage for the portion of the plurality of nodes at a time interval subsequent to the initial time interval. The machine-learned model can include one or more features of the one or more machine-learned models 120 depicted in FIG. 1, the one or more machine-learned models 140 that is depicted in FIG. 1, and/or the network state determination model 202 that is depicted in FIG. 2). For example, the computing device 102 can include a machine-learned model (e.g., the one or more machine-learned models 120) that receives the network data (e.g., the network data of 902) as an input from another portion of the computing device 102 or from another computing device or computing system (e.g., the server computing system 130). The one or more machine-learned models 120 of the computing device 102 can then generate an output based on the network data. Furthermore, the output from the one or more machine-learned models 120 can include the resource availability and the resource usage for the portion of the plurality of nodes at a time interval subsequent to the initial time interval. By way of example, using the one or more machine-learned models 120, the computing device 102 can determine the resource availability and resource usage of electrical power for the hour subsequent to the initial time period.

In some embodiments, the machine-learned model can include one or more of a support vector machine, a neural network (e.g., convolutional neural network), a support vector machine, and/or a decision tree.

At 906, the method 900 can include generating, based at least in part on the network data, one or more predictions (e.g., predictions of the state of the network including resource availability, resource usage, and/or resource cost) for the portion of the plurality of nodes. For example, the computing device 102 can generate one or more predictions associated with the amount of electrical power that will be available from a portion of the electrical power stations in an electrical energy grid. Further, the one or more predictions can include a plurality of time intervals with corresponding confidence levels associated with the accuracy of the predictions for each of the plurality of time intervals.

In some embodiments, the one or more predictions can include a resource cost (e.g., an amount of another resource or commodity that can be exchanged for some amount of the resource) for the resource available for distribution from each node of at least the portion of the plurality of nodes at the time interval subsequent to the initial time interval. For example, the computing device 102 can generate one or more predictions including a predicted cost of electrical power one hour subsequent to the initial time interval.

Furthermore, in some embodiments, the one or more predictions can include a set of resource costs for the resource available for distribution from each of the plurality of nodes at the time interval subsequent to the initial time interval. For example, the computing device 102 can generate one or more predictions for an electrical grid including the cost of electrical power at each of the plurality of nodes associated with a corresponding plurality of electrical power stations of the electrical grid.

At 908, the method 900 can include generating data indicative of at least one network optimization based at least in part on the one or more predictions. For example, the computing device 102 can, based at least in part on the one or more predictions, generate data indicating one or more ways to optimize the network including the plurality of nodes. The network optimization can include a different combination of the resource generation mix (e.g., different combinations of solar power, hydroelectric power, and/or natural gas power) and/or changes to the available capacity of the one or more nodes. By way of further example, based on data associated with the one or more predictions (e.g., a predicted future resource usage) the computing device 102 can generate one or more control signals that can be used to activate one or more devices and/or systems associated with providing and/or generating the resource within the network. For example, based on one or more predictions that the demand for a resource (e.g., electrical power) will decrease in one hour, the network computing system can send one or more signals to begin a reduction in the amount of electrical power that is provided by one or more electrical power stations.

At 910, the method 900 can include controlling one or more of the plurality of nodes based at least in part on the one or more predictions. The method can also include controlling at least part of the network based at least in part on the one or more predictions. For example, the computing device 102 can control one or more nodes based on the one or more predictions (e.g., a prediction that the demand for electrical energy will increase at certain times of the day or of the year). Controlling the one or more nodes can include increasing or decreasing the amount of the resource that is provided by each of the plurality of nodes at various time intervals. By way of example, the computing device 102 can send one or more signals or data to electrical power stations associated with the plurality of nodes. The one or more signals or data sent by the computing device 102 can include data indicating adjustments to the amount of the resource that is provided by each of the plurality of nodes, the rate at which the resource is provided by each of the plurality of nodes, and whether each of the plurality of nodes should be active (e.g., on-line and capable of providing a resource).

FIG. 10 depicts a flow chart diagram of an example method to perform network topology determination and prediction according to example embodiments of the present disclosure. One or more portions of the method 1000 can be executed or implemented on one or more computing devices or computing systems including, for example, the computing device 102, the server computing system 130, and/or the training computing system 150. Further, one or more portions of the method 1000 can be executed or implemented as an algorithm on the hardware devices or systems disclosed herein. FIG. 10 depicts steps performed in a particular order for purposes of illustration and discussion. In some embodiments, one or more portions of the method 1000 can be performed as part of the method 900 that is depicted in FIG. 9. Those of ordinary skill in the art, using the disclosures provided herein, will understand that various steps of any of the methods disclosed herein can be adapted, modified, rearranged, omitted, and/or expanded without deviating from the scope of the present disclosure.

At 1002, the method 1000 can include receiving historical training data. The historical data can include historical resource availability, historical resource usage, and/or a ground-truth resource cost for a resource provided in association with at least the portion of the plurality of nodes over a plurality of time intervals preceding the initial time interval.

For example, the one or more machine-learned models 120 in the computing device 102, the one or more machine-learned models 140 in the server computing system 130, and/or the network state determination model in the machine-learned computing device 200, can receive, from the training computing system 150 via the network 180, historical training data (e.g., the training data 162) to the one or more machine-learned models 120 in the computing device 102 and/or the one or more machine-learned models 140 in the server computing system 130. Further, the historical training data can include information associated with historical resource availability (e.g., an amount of electrical power available for dispatch, at one or more intervals in the past, from each of a plurality of power generation stations associated with the plurality of nodes), historical resource usage (e.g., an amount of electrical power consumed by consumers, at one or more intervals in the past, from each of a plurality of power generation stations associated with the plurality of nodes), and/or a ground-truth resource cost for a resource (e.g., the cost of electrical power, at one or more time intervals in the past, from each of a plurality of power generation stations associated with the plurality of nodes).

The historical resource availability can include the availability of a resource or a plurality of resources at one or more time intervals in the past. For example, the historical resource availability can include an availability of electricity from an electrical power grid, availability of network bandwidth in a computing network, and/or availability of water from a water reservoir system.

In some embodiments, receiving historical training data can be performed as part of the method 900 that is depicted in FIG. 9.

At 1004, the method 1000 can include training the machine-learned model using the historical training data. For example, the training computing system 150 can send historical training data to the one or more machine-learned models 120 of the computing device 102 and/or the one or more machine-learned models 140 of the server computing system 130. The one or more machine-learned models 120 and/or the one or more machine-learned models 140 (e.g., convolutional neural networks) can receive the historical training data as a training input, and perform one or more operations including using, for example multinomial logistic regression classification, to generate an output including, for each of the plurality of nodes associated with the historical training data, resource availability, resource usage, and/or resource cost at one or more time intervals subsequent to one or more time intervals associated with the historical training data.

Furthermore, the historical training data can include information associated with the state or condition of the network including the plurality of nodes. The historical training data can include a type of resource (e.g., electrical power, network bandwidth, and/or water), availability of a resource (e.g., an amount of the resource that can be accessed or provided), usage of a resource (e.g., an amount of a resource used by consumers), resource capacity (e.g., a total amount of a resource which can include a portion of the resource that is not available for distribution), and/or resource cost.

In some embodiments, training the machine-learned model using the historical training data can be performed as part of the method 900 that is depicted in FIG. 9.

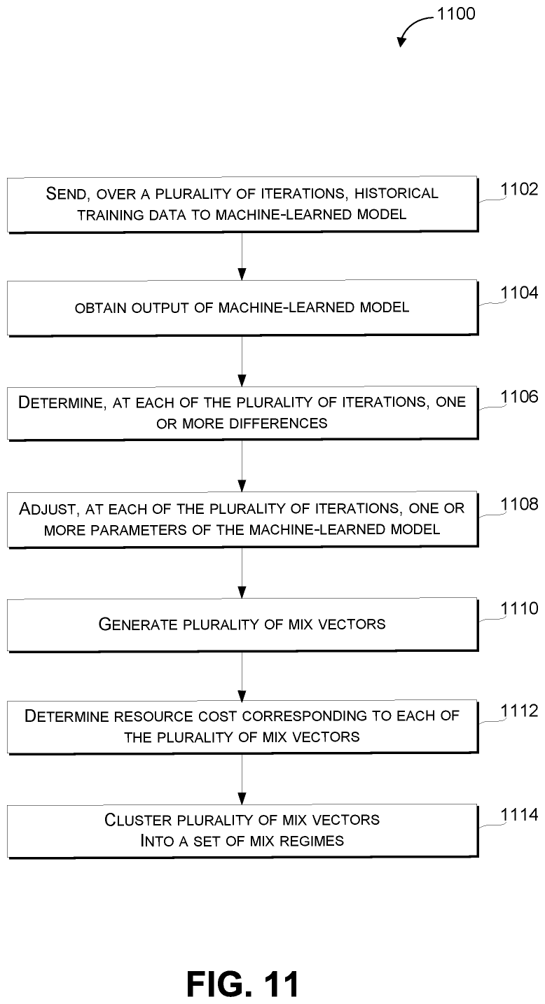

FIG. 11 depicts a flow chart diagram of an example method to perform network topology determination and prediction according to example embodiments of the present disclosure. One or more portions of the method 1100 can be executed or implemented on one or more computing devices or computing systems including, for example, the computing device 102, the server computing system 130, and/or the training computing system 150. Further, one or more portions of the method 1100 can be executed or implemented as an algorithm on the hardware devices or systems disclosed herein. FIG. 11 depicts steps performed in a particular order for purposes of illustration and discussion. In some embodiments, one or more portions of the method 1100 can be performed as part of the method 900 depicted in FIG. 9 and/or as part of training the machine-learned model using the historical training data that is described in 1002 or 1004 of the method 1000 that is depicted in FIG. 10. Those of ordinary skill in the art, using the disclosures provided herein, will understand that various steps of any of the methods disclosed herein can be adapted, modified, rearranged, omitted, and/or expanded without deviating from the scope of the present disclosure.

At 1102, the method 1100 can include sending, over a plurality of iterations, a portion of the historical training data to the machine-learned model. The machine-learned model can include one or more features of the one or more machine-learned models 120 that is depicted in FIG. 1, the one or more machine-learned models 140 that is depicted in FIG. 1, and/or the network state determination model 202 that is depicted in FIG. 2). The portion of the historical training data can include the historical resource availability and/or the historical resource usage of at least the portion of the plurality of nodes.

For example, the training computing system 150 can send, over a plurality of iterations, a portion of historical training data (e.g., the training data 162) to the one or more machine-learned models 120 in the computing device 102 and/or the one or more machine-learned models 140 in the server computing system 130. Further, by way of example, the historical training data can include the amount of historical resource availability (e.g., network bandwidth availability in the past) and the amount of historical resource usage (e.g., communications network bandwidth usage in the past) for a portion of the nodes (e.g., half or all of the nodes associated with respective computing devices in a communications network) every minute over the period of a day in the past.

In some embodiments, sending, over a plurality of iterations, a portion of the historical training data to the machine-learned model can be used in training the machine-learned model using the historical training data as described in 1002 and/or 1004 of the method 1000 that is depicted in FIG. 10.

At 1104, the method 1100 can include, responsive to sending the historical training data to the machine-learned model, obtaining, at each of the plurality of iterations, an output of the machine-learned model that can include a predicted resource cost of the resource provided at each of the plurality of nodes. For example, responsive to the training computing system 150 sending the historical training data (e.g., the training data 162) to the one or more machine-learned models 120 in the computing device 102 or the one or more machine-learned models 140 in the server computing device 130, the training computing system 150 can obtain, at each of the plurality of iterations, output data from the one or more machine-learned models 120 and/or the one or more machine-learned models 140 which can include information associated with the predicted resource cost of the resource provided at each of the plurality of nodes. Further, the output data can include data associated with the predicted resource cost of the resource provided at each of the plurality of nodes (e.g., the predicted cost of network bandwidth).

In some embodiments, responsive to sending the historical training data to the machine-learned model, obtaining, at each of the plurality of iterations, an output of the machine-learned model that can include a predicted resource cost of the resource provided at each of the plurality of nodes can be used in training the machine-learned model using the historical training data as described in 1002 and/or 1004 of the method 1000 that is depicted in FIG. 10.

At 1106, the method 1100 can include determining, at each of the plurality of iterations, one or more differences between the predicted resource cost and the ground-truth resource cost at each of the plurality of nodes. For example, the training computing system 150 can, at each of the plurality of iterations, determine one or more differences between the predicted resource cost and the ground-truth resource cost at each of the plurality of nodes by comparing the predicted resource cost to the ground-truth resource cost. By way of further example, the training computing system 150 can determine one or more differences in the predicted cost of network bandwidth to the ground-truth network bandwidth cost that is included in the historical training data.

In some embodiments, determining, at each of the plurality of iterations, one or more differences between the predicted resource cost and the ground-truth resource cost at each of the plurality of nodes can be used in training the machine-learned model using the historical training data as described in 1002 and/or 1004 of the method 1000 that is depicted in FIG. 10.

At 1108, the method 1100 can include adjusting, at each of the plurality of iterations, one or more parameters of the machine-learned model to minimize the one or more differences between the predicted resource cost and the ground-truth resource cost at each of the plurality of nodes. For example, the training computing system 150 can perform one or more operations including using a cost function to compare the one or more differences between the predicted resource cost of network bandwidth and the ground-truth resource cost of network bandwidth at each of the plurality of nodes. By way of further example, greater differences between the predicted resource cost and the ground-truth resource cost can result in a correspondingly greater adjustment of the one or more parameters or weights of the machine-learned model. Further, smaller differences between the predicted resource cost and the ground-truth resource cost can result in a correspondingly smaller adjustment of the one or more parameters or weights of the machine-learned model.

In some embodiments, adjusting, at each of the plurality of iterations, one or more parameters of the machine-learned model to minimize the one or more differences between the predicted resource cost and the ground-truth resource cost at each of the plurality of nodes can be used in training the machine-learned model using the historical training data as described in 1002 and/or 1004 of the method 1000 that is depicted in FIG. 10.

At 1110, the method 1100 can include generating, for the plurality of nodes at a plurality of time intervals preceding the initial time interval, a plurality of mix vectors including the resource generation type and the resource usage at each of the plurality of time intervals preceding the initial time interval. For example, the computing device 102 can generate a plurality of mix vectors associated with the generation of electrical energy in an electrical grid of a region (e.g., city). The plurality of mix vectors can include mix vectors, each of which include a combination of power generation types (e.g., solar power generation, hydroelectric power generation, coal power generation, diesel power generation) at different time intervals (e.g., a plurality of mix vectors and corresponding resource availability and resource usage over a plurality of time intervals).

In some embodiments, the plurality of mix vectors can be scaled (e.g., scaling data in the plurality of mix vectors associated with resource usage and resource availability so that the range of independent variables is standardized).

In some embodiments, generating, for the plurality of nodes at a plurality of time intervals preceding the initial time interval, a plurality of mix vectors including the resource generation type and the resource usage at each of the plurality of time intervals preceding the initial time interval can be used in training the machine-learned model using the historical training data as described in 1002 and/or 1004 of the method 1000 that is depicted in FIG. 10.

At 1112, the method 1100 can include determining the resource cost corresponding to each of the plurality of mix vectors at each of the plurality of time intervals preceding the initial time interval. For example, the computing device 102 can determine the resource cost corresponding to each of the plurality of mix vectors at each of the plurality of time intervals preceding the initial time interval based on the historical resource costs stored in the historical training data.

In some embodiments, determining the resource cost corresponding to each of the plurality of mix vectors at each of the plurality of time intervals preceding the initial time interval can be used in training the machine-learned model using the historical training data as described in 1002 and/or 1004 of the method 1000 that is depicted in FIG. 10.

At 1114, the method 1100 can include clustering the plurality of mix vectors into a set of mix regimes based at least in part on the resource cost at each of the plurality of time intervals preceding the initial time interval. Further, the plurality of mix regimes can include a distribution of the plurality of mix vectors (e.g., the distribution of power generation types associated with each mix regime of the plurality of mix regimes). For example, the computing device 102 can use one or more clustering techniques (e.g., k-means clustering) to cluster the mix vectors into a set of mix regimes based on the resource cost at each of the plurality of time intervals. The computing device 102 can, for example, cluster the mix vectors into mix regimes based on the mix regime clusters that result in the lowest resource cost.

In some embodiments, clustering the plurality of mix vectors into a set of mix regimes based at least in part on the resource cost at each of the plurality of time intervals preceding the initial time interval can include classifying the plurality of mix vectors including the application of Principal Component Analysis (PCA). For example, the computing system 102 can use PCA to determine a set of resource costs associated with the plurality of nodes based on previously determined data (e.g., the historical training data described in 1002 and 1004 of the method 1000 that is depicted in FIG. 10) associated with the state of the network (e.g., the resource availability and resource usage in the past).

In some embodiments, clustering the plurality of mix vectors into a set of mix regimes based at least in part on the resource cost at each of the plurality of time intervals preceding the initial time interval can be used in training the machine-learned model using the historical training data as described in 1002 and/or 1004 of the method 1000 that is depicted in FIG. 10.

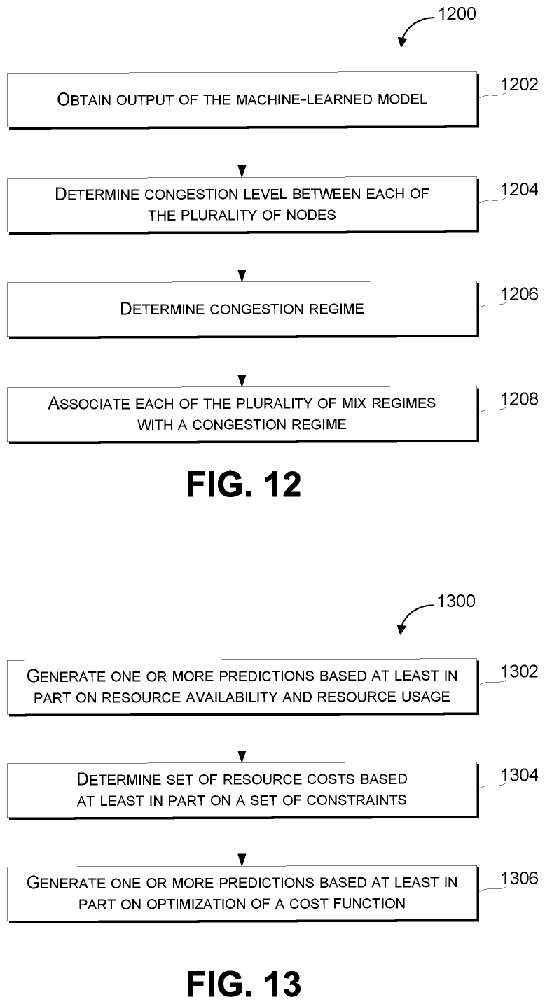

FIG. 12 depicts a flow chart diagram of an example method to perform network topology determination and prediction according to example embodiments of the present disclosure. One or more portions of the method 1200 can be executed or implemented on one or more computing devices or computing systems including, for example, the computing device 102, the server computing system 130, and/or the training computing system 150. Further, one or more portions of the method 1200 can be executed or implemented as an algorithm on the hardware devices or systems disclosed herein. FIG. 12 depicts steps performed in a particular order for purposes of illustration and discussion. In some embodiments, one or more portions of the method 1200 can be performed as part of training the machine-learned model using the historical training data as described in 1004 of the method 1000 that is depicted in FIG. 10. Those of ordinary skill in the art, using the disclosures provided herein, will understand that various steps of any of the methods disclosed herein can be adapted, modified, rearranged, omitted, and/or expanded without deviating from the scope of the present disclosure.

At 1202, the method 1200 can include obtaining, over a plurality of iterations, an output of the machine-learned model including determined resource availability and a determined resource usage at the portion of the plurality of nodes. The machine-learned model can include one or more features of the one or more machine-learned models 120 depicted in FIG. 1, the one or more machine-learned models 140 depicted in FIG. 1, and/or the network state determination model 202 that is depicted in FIG. 2). For example, the computing device 102 can obtain, over a plurality of iterations, output data from the one or more machine-learned models 140 which can include information associated with determined resource availability and a determined resource usage at the portion of the plurality of nodes.

In some embodiments, obtaining, over a plurality of iterations, an output of the machine-learned model including determined resource availability and a determined resource usage at the portion of the plurality of nodes can be performed as part of training the machine-learned model using the historical training data as described in 1004 of the method 1000 that is depicted in FIG. 10.

At 1204, the method 1200 can include determining, at each of the plurality of iterations, based at least in part on the historical training data, a congestion level between each of the plurality of nodes. The congestion level can be associated with an amount that the determined resource usage exceeds the determined resource availability at the time interval subsequent to the initial time interval. For example, the computing device 102 can determine that when the determined resource availability is greater than the determined resource usage at the time subsequent to the initial time interval, the congestion level can be at its lowest level (e.g., a congestion level of zero on a scale of one to ten when the determined resource usage of electrical power is half the determined resource availability of electrical power). The computing device 102 can determine that when the determined resource usage exceeds the determined resource availability by an intermediate amount at the time interval subsequent to the initial time interval, the congestion level can be at an intermediate level (e.g., a congestion level of three on a scale of one to ten when the determined resource usage of electrical power is thirty percent greater than the determined resource availability of electrical power). The computing device 102 can determine that when the determined resource usage greatly exceeds the determined resource availability at the time interval subsequent to the initial time interval, the congestion level can be high (e.g., a congestion level of ten on a scale of one to ten when the determined resource usage of electrical power is double the determined resource availability of electrical power).

Furthermore, in some embodiments, the congestion level can be associated with one or more events and/or the state of the plurality of nodes that reduces the rate at which the resource can be provided, distributed, or dispatched from each of the plurality of nodes. The congestion level can also be associated with the extent of resource availability and/or resource usage at any of the plurality of nodes in comparison to a respective baseline level of resource availability of resource usage.

For example, the computing device 102 can determine, at each of the plurality of iterations, based at least in part on the historical training data (e.g., the training data 162) received from the training computing system 150, a congestion level between each of the plurality of nodes associated with a corresponding plurality of communications network devices (e.g., computing devices, routers, and/or switches). The congestion level can be based at least in part on the rate (e.g., megabits per second) at which one or more signals or data are transmitted through the communications network.

In some embodiments, determining, at each of the plurality of iterations, based at least in part on the historical training data, a congestion level between each of the plurality of nodes can be performed as part of training the machine-learned model using the historical training data as described in 1004 of the method 1000 that is depicted in FIG. 10.

At 1206, the method 1200 can include determining, based at least in part on the congestion level between each of the plurality of nodes at the plurality of time intervals preceding the initial time interval, a congestion regime of a plurality of congestion regimes for the plurality of nodes. The congestion regime can be associated with the plurality of nodes having a congestion level that satisfies one or more predetermined congestion criteria. The one or more predetermined congestion criteria can include the determined resource usage exceeding the determined resource availability or being within a predetermined amount (e.g., predetermined portion or predetermined absolute amount of the determined resource availability. For example, the computing device 102 can determine a congestion regime for the plurality of nodes based on data associated with the congestion level between each of the plurality of nodes (e.g., a plurality of devices in a communications network) at the plurality of time intervals (e.g., time intervals of one minute). Furthermore, in some embodiments, the plurality of congestion regimes can be associated with specific time intervals (e.g., times of the day) at which the one or more predetermined congestion criteria are satisfied. For example, the computing device 102 can determine that congestion in a communications network peaks between the hours of nine a.m. and ten a.m.

In some embodiments, the one or more predetermined congestion criteria can include a predetermined portion of the plurality of nodes (e.g., a majority of the plurality of nodes) being associated with a congestion level that exceeds a predetermined congestion threshold (e.g., the determined resource usage exceeding the determined resource availability or the determined resource usage being within five percent of the determined resource availability).

In some embodiments, determining, based at least in part on the congestion level between each of the plurality of nodes at the plurality of time intervals preceding the initial time interval, a congestion regime of a plurality of congestion regimes for the plurality of nodes can be performed as part of training the machine-learned model using the historical training data as described in 1004 of the method 1000 that is depicted in FIG. 10.

At 1208, the method 1200 can include associating each of the plurality of mix regimes with a congestion regime of the plurality of congestion regimes. For example, the computing device 102 can generate data including an association between each of the plurality of mix regimes and a selected congestion regime that satisfies the one or more predetermined congestion criteria.

In some embodiments, multinomial logistic regression classification can be used in associating each of the plurality of mix regimes with a congestion regime of the plurality of congestion regimes.

In some embodiments, associating each of the plurality of mix regimes with a congestion regime of the plurality of congestion regimes can be performed as part of training the machine-learned model using the historical training data as described in 1004 of the method 1000 that is depicted in FIG. 10.

FIG. 13 depicts a flow chart diagram of an example method to perform network topology determination and prediction according to example embodiments of the present disclosure. One or more portions of the method 1300 can be executed or implemented on one or more computing devices or computing systems including, for example, the computing device 102, the server computing system 130, and/or the training computing system 150. Further, one or more portions of the method 1300 can be executed or implemented as an algorithm on the hardware devices or systems disclosed herein. FIG. 13 depicts steps performed in a particular order for purposes of illustration and discussion. In some embodiments, one or more portions of the method 1300 can be performed as part of generating, based at least in part on the network data, one or more predictions for the portion of the plurality of nodes as described in 906 of the method 900 that is depicted in FIG. 9. Those of ordinary skill in the art, using the disclosures provided herein, will understand that various steps of any of the methods disclosed herein can be adapted, modified, rearranged, omitted, and/or expanded without deviating from the scope of the present disclosure.

At 1302, the method 1300 can include generating the one or more predictions based at least in part on the resource availability and the resource usage. For example, the computing device 102 can use the resource availability (e.g., availability of electrical power in an electrical power grid) and the resource usage (e.g., usage by consumers of electrical power from the electrical power grid) to generate one or more predictions including a predicted cost of electrical power one hour subsequent to the initial time interval.

In some embodiments, generating the one or more predictions based at least in part on the resource availability and the resource usage can be performed as part of generating, based at least in part on the network data, one or more predictions for the portion of the plurality of nodes as described in 906 of the method 900 that is depicted in FIG. 9.

At 1304, the method 1300 can include determining the set of resource costs based at least in part on a set of constraints including transmission constraints associated with one or more connections between the plurality of nodes and/or resource generation constraints associated with an amount of the resource that can be distributed from each of the plurality of nodes. For example, the computing device 102 can determine a set of resource costs associated with an electrical power grid based at least in part on the transmission constraints (e.g., constraints of the power lines between the electrical power stations including the maximum load of power lines, temperature constraints, weather constraints, and/or constraints associated with the availability of connecting electrical power stations) associated with the ability of each of the electrical power stations of the electrical power grid to distribute or dispatch electricity.

In some embodiments, determining the set of resource costs based at least in part on a set of constraints including transmission constraints associated with one or more connections between the plurality of nodes and/or resource generation constraints associated with an amount of the resource that can be distributed from each of the plurality of nodes can be performed as part of generating, based at least in part on the network data, one or more predictions for the portion of the plurality of nodes as described in 906 of the method 900 that is depicted in FIG. 9.

At 1306, the method 1300 can include determining the one or more predictions based at least in part on optimization of a cost function associated with optimal power flow for at least the portion of the plurality of nodes. For example, the computing device 102 can use the network data to optimize a cost function associated with optimal power flow by determining the least cost to provide the resource in a subsequent time interval at each of the plurality of nodes (e.g., the cost of providing electrical power in the next hour from each of a plurality of nodes associated with a corresponding plurality of electrical power stations).

In some embodiments, determining the one or more predictions based at least in part on optimization of a cost function associated with optimal power flow for at least the portion of the plurality of nodes can be performed as part of generating, based at least in part on the network data, one or more predictions for the portion of the plurality of nodes as described in 906 of the method 900 that is depicted in FIG. 9.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method of network topology prediction, the method comprising:
receiving, by one or more computing devices, network data comprising information associated with a network comprising a plurality of nodes associated with a resource availability and a resource usage, wherein the resource availability is associated with an amount of a resource dispatched in association with at least a portion of the plurality of nodes at an initial time interval, and wherein the resource usage is associated with usage of the resource in association with at least a portion of the plurality of nodes at the initial time interval;
determining, by the one or more computing devices, based at least in part on the network data and a machine-learned model, the resource availability and the resource usage for at least the portion of the plurality of nodes at a time interval subsequent to the initial time interval; and
generating, by the one or more computing devices, based at least in part on the network data, one or more predictions for at least one of the plurality of nodes.

2. The computer-implemented method of claim 1, wherein the network data comprises resource availability data indicative of a total resource supply dispatched in association with the plurality of nodes during the initial time interval; and
the network data comprises resource usage data indicative of a plurality of resource usages associated with a plurality of regions during the initial time interval, each region comprising a subset of the plurality of nodes.

3. (canceled)

4. The computer-implemented method of claim 1, wherein the resource availability comprises power dispatched in association with at least the portion of the plurality of nodes; and
the resource usage comprises power demand of the at least the portion of the plurality of nodes.

5. The computer-implemented method of claim 1, wherein the resource availability comprises bandwidth availability associated with at least the plurality of nodes; and
the resource usage comprises bandwidth demand of at least the portion of the plurality of nodes.

6. The computer-implemented method of claim 1, wherein the plurality of nodes is associated with a corresponding plurality of energy distribution locations of an electrical power grid, and wherein the resource comprises electrical power.

7. The computer-implemented method of claim 1, further comprising:
generating, by the one or more computing devices, data indicative of at least one network optimization based at least in part on the one or more predictions.

8. The computer implemented method of claim 1, further comprising:
controlling, by the one or more computing devices, one or more of the plurality of nodes based at least in part on the one or more predictions.

9. The computer-implemented method of claim 1, further comprising:
receiving, by the one or more computing devices, historical training data comprising historical resource availability, historical resource usage, and a ground-truth resource cost for a resource provided in association with at least the portion of the plurality of nodes over a plurality of time intervals preceding the initial time interval; and
training, by the one or more computing devices, the machine-learned model using the historical training data.

10. The computer-implemented method of claim 9, wherein training, by the one or more computing devices, the machine-learned model using the historical training data comprises:
sending, by the one or more computing devices, over a plurality of iterations, a portion of the historical training data to the machine-learned model, wherein the portion of the historical training data comprises the historical resource availability and the historical resource usage of at least the portion of the plurality of nodes; and
responsive to sending the historical training data to the machine-learned model, obtaining, by the one or more computing devices, at each of the plurality of iterations, an output of the machine-learned model comprising a predicted resource cost of the resource provided at each of the plurality of nodes;
determining, by the one or more computing devices, at each of the plurality of iterations, one or more differences between the predicted resource cost and the ground-truth resource cost at each of the plurality of nodes; and
adjusting, by the one or more computing devices, at each of the plurality of iterations, one or more parameters of the machine-learned model to minimize the one or more differences between the predicted resource cost and the ground-truth resource cost at each of the plurality of nodes.

11. The computer-implemented method of claim 9, wherein each of the plurality of nodes is associated with one or more resource generation types of a plurality of resource generation types, and wherein the resource generation type is based at least in part on a way that each of the plurality of nodes generates the resource.

12-20. (canceled)

21. The computer-implemented method of claim 1, wherein the one or more predictions comprise a set of resource costs for the resource available for distribution from each of the plurality of nodes at the time interval subsequent to the initial time interval, and wherein generating, by the one or more computing devices, based at least in part on the network data, one or more predictions for at least one of the plurality of nodes comprises:
determining, by the one or more computing devices, the set of resource costs based at least in part on a set of constraints comprising transmission constraints associated with one or more connections between the plurality of nodes or resource generation constraints associated with an amount of the resource that can be distributed from each of the plurality of nodes.

22. The computer-implemented method of claim 1, wherein the one or more predictions comprise a resource cost for the resource available for distribution from each node of at least the portion of the plurality of nodes at the time interval subsequent to the initial time interval.

23. A computing system comprising:
one or more processors;
a machine-learned model trained to receive input data comprising information associated with a plurality of nodes associated with a resource availability and a resource usage, and based at least in part on the input data, generate output data comprising one or more predictions associated with at least a portion of the plurality of nodes; and
a memory comprising one or more computer-readable media, the memory storing computer-readable instructions that when executed by the one or more processors cause the one or more processors to perform operations comprising:
receiving the input data comprising information associated with a plurality of nodes respectively associated with a resource availability and a resource usage, wherein the resource availability is associated with an amount of a resource dispatched in association with at least a portion of the plurality of nodes at an initial time interval, and wherein the resource usage is associated with usage of the resource in association with the at least a portion of the plurality of nodes at the initial time interval;
sending the input data to the machine-learned model, wherein the machine-learned model is configured to determine, based at least in part on the input data, output data comprising the resource availability and the resource usage for at least the portion of the plurality of nodes at a time interval subsequent to the initial time interval; and
responsive to receiving output data from the machine-learned model, generating, based at least in part on the output data from the machine-learned model, one or more predictions for at least the portion of the plurality of nodes, wherein the one or more predictions comprises a resource cost for the resource available for distribution from each of the plurality of nodes at the time interval subsequent to the initial time interval.

24. The computing system of claim 23, wherein responsive to receiving output data from the machine-learned model, generating, based at least in part on the output data from the machine-learned model, one or more predictions for at least the portion of the plurality of nodes, wherein the one or more predictions comprises a resource cost for the resource available for distribution from each of the plurality of nodes at the time interval subsequent to the initial time interval comprises:
determining the one or more predictions based at least in part on optimization of a cost function associated with optimal power flow for at least the portion of the plurality of nodes.

25. The computing system of claim 23, wherein the machine-learned model comprises a convolutional neural network or a support vector machine.

26. The computing system of claim 23, wherein the computer-readable instructions that when executed by the one or more processors cause the one or more processors to control one or more of the plurality of nodes in dependence on the one or more predictions.

27. One or more tangible non-transitory computer-readable media storing computer-readable instructions that when executed by one or more processors cause the one or more processors to perform operations, the operations comprising:
receiving network data comprising information associated with a network comprising a plurality of nodes associated with a resource availability and a resource usage, wherein the resource availability is associated with an amount of a resource available for distribution from a portion of the plurality of nodes at an initial time interval, and wherein the resource usage is associated with usage of the resource from the portion of the plurality of nodes at the initial time interval;
determining, based at least in part on the network data and a machine-learned model, the resource availability and the resource usage for the portion of the plurality of nodes at a time interval subsequent to the initial time interval; and
generating, based at least in part on the network data, one or more predictions for the plurality of nodes, wherein the one or more predictions comprises a resource cost for the resource available for distribution from each of the plurality of nodes at the time interval subsequent to the initial time interval.

28. The one or more tangible non-transitory computer-readable media of claim 27, wherein each of the plurality of nodes is associated with a resource loss value corresponding to an amount of the resource that is lost in a predetermined time interval before being distributed from a respective node of the plurality of nodes.

29. The one or more tangible non-transitory computer-readable media of claim 27, wherein each of the plurality of nodes is associated with a congestion value corresponding to a reduction in the rate at which the resource can be distributed from a respective node of the plurality of nodes.

30. The one or more tangible non-transitory computer-readable media of claim 27, wherein the computer-readable instructions that when executed by one or more processors further cause the one or more processors to control one or more of the plurality of nodes in dependence on the one or more predictions.
